(19) United States
(12) Patent Application Publication
(10) Pub. No.: US 2008/0159708 A1
(43) Pub. Date: Jul. 3, 2008

(54) Video Contents Display Apparatus, Video Contents Display Method, and Program Therefor

(75) Inventors: Hisashi Kazama, Kanagawa (JP); Takahisa Yoneyama, Kanagawa (JP); Takashi Nakamura, Tokyo (JP); Goh Uemura, Kanagawa (JP); Masayuki Horikawa, Kanagawa (JP); Tatsuya Uehara, Kanagawa (JP); Koichi Awazu, Saitama (JP); Hiroyuki Ikemoto, Kanagawa (JP)

Correspondence Address: SPRINKLE IP LAW GROUP, 1301 W. 25TH STREET, SUITE 408, AUSTIN, TX, 78705, US

(73) Assignee: Kabushiki Kaisha Toshiba, Tokyo (JP)

(21) Appl. No.: 11/964,277

(22) Filed: Dec. 26, 2007

(30) Foreign Application Priority Data
Dec. 27, 2006 (JP) 2006-353421

(51) Int. Cl. H04N 5/915

(52) U.S. Cl. 386/69; 725/37; 715/719; 386/E05.003

(57) ABSTRACT

A video contents display apparatus include a display generation unit for: generating a predetermined number of static images by considering a time of lapse from information about recorded video contents; converting a static image other than at least one specified static image into an image reduced in a predetermined format from the predetermined number of generated static images; and displaying a sequence of images by arranging the at least one static image and the other static image along a predetermined path on a screen by considering the time of lapse.

### CROSS REFERENCE TO RELATED APPLICATION

This application is based upon and claims the benefit of priority from the prior Japanese Patent Application No. 2006-353421 filed on Dec. 27, 2006; the entire contents of which are incorporated herein by this reference.

### BACKGROUND OF THE INVENTION

1. Field of the Invention

The present invention relates to a video contents display apparatus, a video contents display method, and a program therefor.

2. Description of the Related Art

Recently, equipment capable of recording video contents such as a TV program etc. for a long time has become widespread. As the recording equipment, there are a hard disk recorder (hereinafter referred to as an HDD recorder for short), a home server, a personal computer (hereinafter referred to as a PC for short), etc. that contain a hard disk device. The tendency comes from a larger storage capacity and a lower cost of the information recording device such as a hard disk device etc.

Using the function of a common HDD recorder, a user selects a desired program to be viewed by narrowing program from plural recorded programs on the listing display of program names etc. At this time, a list of plural programs to be selected is displayed in a so-called thumbnail format, and a user selects a program while checking the thumbnail images.

In addition, there has recently been an apparatus practically capable of recording plural programs currently being broadcast using a built-in tuner. For example, refer to the URL http://www.vaio.sony.co.jp/Products?/VGX.X90P/. The display of plural programs on the device is similar to the display of weekly program table on a newspaper.

However, in the above-mentioned conventional devices, although plural video contents are recorded on an HDD recorder, a home server, etc., related scenes have not been able to be retrieved from among recorded video contents.

In retrieving video contents, a list of titles of plural video contents has been able to be displayed along a time axis of the date and time of recording. However, the retrieval has not been able to be performed with various time relations taken into account. For example, it is possible to retrieve “contents recorded in the year of XX” from a database storing plural video contents by setting the “year of XX” in the retrieval conditions. However, it has not been possible to retrieve contents with plural time relations taken into account such as retrieving video contents with period settings of the time in which specific video contents were viewed.

### SUMMARY OF THE INVENTION

The video contents display apparatus according to an aspect of the present invention includes: a static image generation unit for generating a predetermined number of static images by considering a time of lapse from information about recorded video contents; an image conversion unit for converting a static image other than at least one specified static image into an image reduced in a predetermined format from the predetermined number of generated static images; and a display unit for displaying a sequence of images by arranging at least the one-static image and the other static image along a predetermined path on a screen by considering the time of laps.

The video contents display method according to an aspect of the present invention is a method of displaying video contents, and includes: generating a predetermined number of static images by considering a time of lapse from information about recorded video contents; converting a static image other than at least one specified static image into an image reduced in a predetermined format from the predetermined number of generated static images; and displaying the at least the one static image and the other compressed static image as a sequence of images arranged along a predetermined path on a screen by considering the time of lapse.

### BRIEF DESCRIPTION OF THE DRAWINGS

FIG. 1 is a block diagram of the configuration of a video contents display system according to an embodiment of the present invention;

FIG. 2 is a block diagram showing an example of the configuration of a processor included in a display generation unit according to an embodiment of the present invention;

FIG. 3 is a plan view of a remote controller showing an example of a key array of a remote controller as an input device according to an embodiment of the present invention;

FIG. 4 is an explanatory view of the data structure of contents information assigned to each content according to an embodiment of the present invention;

FIG. 5 is an explanatory view of the details of time axis data shown in FIG. 4;

FIG. 6 is an explanatory view of the details of viewer data shown in FIG. 4;

FIG. 7 is an explanatory view of the details of list data shown in FIG. 4;

FIG. 8 is an explanatory view of the details of time series data shown in FIG. 4;

FIG. 9 shows a display example of a three-dimensional display of plural contents in a predetermined display mode according to an embodiment of the present invention;

FIG. 10 is an explanatory view of the position relation between three time axes and one content;

FIG. 11 shows a display example of a user view space when a view point etc. is changed to allow the Y axis to pass through the central point of the screen according to an embodiment of the present invention;

FIG. 12 is an explanatory view of the position relation of each content in the display shown in FIG. 9 or FIG. 11;

FIG. 13 shows an example of the display as the representation of each content having the length forward and backward according to the time axis information in an embodiment of the present invention;

FIG. 14 shows an example of a screen display when a set of contents and scenes are displayed in a three-dimensional array with respect to video equipment such as a digital television etc. according to an embodiment of the present invention;

FIG. 15 is a flowchart of an example of the flow of the process of the display generation unit to display FIG. 9, 11, 13, or 14 on the display screen of the output device according to an embodiment of the present invention;

FIG. 16 is an explanatory view of the relationship between the absolute time space and a user view space;

FIG. 17 shows the state of the display of a predetermined submenu by operating a remote controller in the state in which the screen shown in FIG. 9 is displayed according to an embodiment of the present invention;

FIG. 18 shows an example of displaying plural related contents retrieved on a desired retrieval condition with respect to the contents selected in FIG. 9 according to an embodiment of the present invention;

FIG. 19 shows the state of displaying a predetermined submenu for retrieving a related scene by operating a remote controller in the state in which the screen shown in FIG. 18 is displayed according to an embodiment of the present invention;

FIG. 20 shows an example of displaying a related scene according to an embodiment of the present invention;

FIG. 21 shows an example of the screen in which a specific corner in a daily broadcast program is retrieved according to an embodiment of the present invention;

FIG. 22 is an explanatory view of selecting a scene using a cross key of a remote controller on the screen on which a related scene is detected and displayed according to an embodiment of the present invention;

FIG. 23 shows an example of a variation of the screen shown in FIG. 21;

FIG. 24 shows an example of displaying a sequence of images as fast forward and fast return bars displayed on the screen according to an embodiment of the present invention;

FIG. 25 shows an example of a variation of display format in which respective image sequences corresponding to four contents are displayed on the four faces of a tetrahedron;

FIG. 26 shows an example of a variation of displaying a sequence of images using a heptahedron 161 in place of the tetrahedron shown in FIG. 25;

FIG. 27 shows an example of displaying four heptahedrons shown in FIG. 26;

FIG. 28 is an explanatory view showing a display example in which the size of each thumbnail image in a sequence of images is changed depending on the time series data according to an embodiment of the present invention;

FIG. 29 shows an example of a variation of the display example shown in FIG. 28;

FIG. 30 is a flowchart of an example of the flow of the process of the display generation unit for displaying a sequence of images of plural static images with respect to plural contents according to an embodiment of the present invention;

FIG. 31 is a flowchart of the flow of the process of displaying a sequence of images of thumbnail images according to an embodiment of the present invention;

FIG. 32 is a flowchart of an example of the flow of the related contents selecting process of a display playback unit according to an embodiment of the present invention;

FIG. 33 is a flowchart of an example of the flow of the highlight display according to an embodiment of the present invention;

FIG. 34 is an explanatory view of the case 2-2 according to an embodiment of the present invention;

FIG. 35 shows a screen about the first countermeasure in a variation example of an embodiment of the present invention;

FIG. 36 is an explanatory view of the second countermeasure according to a variation example of an embodiment of the present invention;

FIG. 37 is an explanatory view of the data structure of time axis data in the contents information in a variation example of an embodiment of the present invention;

FIG. 38 is an example of displaying plural contents in a virtual space configured by three time axes in a three-dimensional array in a predetermined display mode in a variation example according to an embodiment of the present invention;

FIG. 39 is an example, as in FIG. 38, of displaying plural contents in a virtual space configured by three time axes in a three-dimensional array in a predetermined display mode in a variation example according to an embodiment of the present invention;

FIG. 40 shows an arrangement of each content and each event shown in FIG. 39 as viewed from the direction orthogonal to the XZ plane;

FIG. 41 shows an arrangement of each content and each event shown in FIG. 39 as viewed from the direction orthogonal to the XY plane;

FIG. 42 shows an arrangement of each content and each event shown in FIG. 39 as viewed from the direction orthogonal to the YZ plane;

FIG. 43 is an explanatory view of another example of displaying an event according to a variation example of an embodiment of the present invention;

FIG. 44 is an explanatory view of the configuration of each block as viewed from the direction orthogonal to the YZ plane in a variation example of an embodiment of the present invention;

FIG. 45 is a flowchart showing an example of the process flow of the screen display shown in FIGS. 38 and 39; and

FIG. 46 shows the process of displaying a user view space shown in FIG. 39.

### DETAILED DESCRIPTION OF THE PREFERRED EMBODIMENTS

Embodiments of the present invention are described below with reference to the attached drawings.

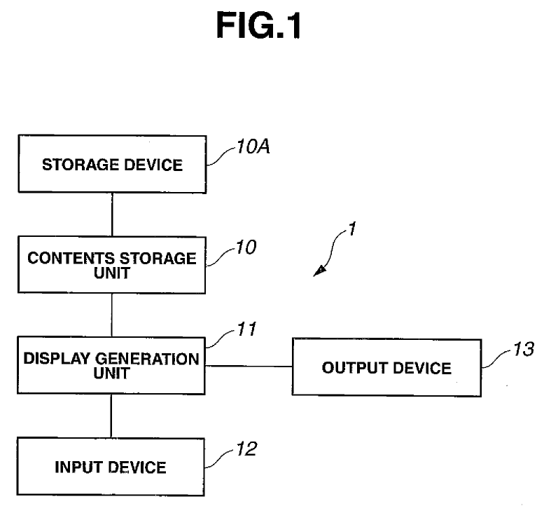

First, the configuration of the video contents display system according to an embodiment of the present invention is described below with reference to FIG. 1. The embodiment of the present invention is described as a video contents display apparatus. Practically, the video contents display apparatus can be a TV display device, TV recording device, or systems of the devices such as a television (TV) recorder etc., a video contents recording medium playback device or a system such as a DVD etc., a device for accumulating or providing plural video contents such as a video network server, a video contents distributing system, etc.

### 1. Configuration of the Apparatus

FIG. 1 is a block diagram of the configuration of the video contents display system according to an embodiment of the present invention.

A video contents display apparatus 1 as a video contents display system includes a contents storage unit 10, a display generation unit 11, an input device 12, and an output device 13.

The contents storage unit 10 is a processing unit for digitizing video contents, and recording and accumulating the resultant contents in a storage device 10A such as an internal hard disk or an external large-capacity memory (that can be connected over a network). The plural video contents accumulated or recorded in the contents storage unit 10 can be various video contents such as contents obtained by recording a broadcast program, distributed toll or free contents, contents captured by each user on a home video device, contents shared and accumulated with friends or at home, contents obtained by recording contents distributed through a packet medium, contents generated or edited by equipment at home, etc.

The display generation unit 11 is a processing unit having a central processing unit (CPU) described later and using the information input from the input device 12 and internally held information about the three-dimensional display to subject the contents accumulated in the contents storage unit 10 to a conversion to allow a three-dimensional image to be projected on a two-dimensional plane, a conversion to allow plural static images to be displayed in a image sequence format various modifications, application of effects, superposing process, etc., so as to generate a screen of a three-dimensional graphical user interface (hereinafter referred to as a GUI for short).

The input device 12 is, for example, a keyboard and a mouse of a computer, a remote controller of a television (TV), a device having the function of a remote controller, etc., and is a device for input for specifying a display method, and for input for a GUI command.

The output device 13 is for example, a display device or a TV screen display device, and displays the screen of a two-dimensional and a three-dimensional GUI. In addition to a display, the output device 13 includes an audio output unit such as a speaker etc. for outputting voice included in video contents.

The descriptions of the functions and processing methods for recording, playing back, editing, and transferring video contents in the video contents display apparatus 1 are omitted here. The video contents display apparatus 1 shown in FIG. 1 can also be used in combination with equipment having other various functions of recording, playing back, editing, and transferring data.

A user can record information about video contents (hereinafter referred to simply as contents) to the storage device 10A through the contents storage unit 10 by transmitting a predetermined command to the display generation unit 11 by operating the input device 12. Then, the user operates the input device 12 and transmits the predetermined command to the video contents display apparatus 1, thereby retrieving and playing back the contents to be viewed from among the plural contents recorded on the storage device 10A through the contents storage unit 10, displaying the contents on the screen of the output device 13, and successfully viewing the contents.

Various processes performed in the video contents display apparatus 1 are integrally executed by the display generation unit 11. The display generation unit 11 includes CPU, ROM, RAM, etc. not shown in the attached drawings. The display generation unit 11 realizes the functions corresponding to various processes such as recording, playing back, etc. by the CPU executing a software program stored in advance in the ROM etc.

In the present embodiment, the CPU has, for example, a multi-core multiprocessor architecture capable of performing parallel processes and executing a real-time OS (operating system). Therefore, the display generation unit 11 can process a large amount of data, especially viewer data in parallel at a high speed.

### 2. Hardware Configuration of the Display Generation Unit

Practically, the display generation unit 11 is configured by a processor capable of performing a parallel process, formed by integrating on one chip a total of nine processors including a 64-bit CPU core, and eight independent signaling processor SPEs (synergistic processing element) for processing a 128-bit register. The SPE is appropriate for processing multimedia data and streaming data. Each SPE has SRAM of a single port for pipeline operation as 256-Kbyte local memory to perform different signal processes in parallel.

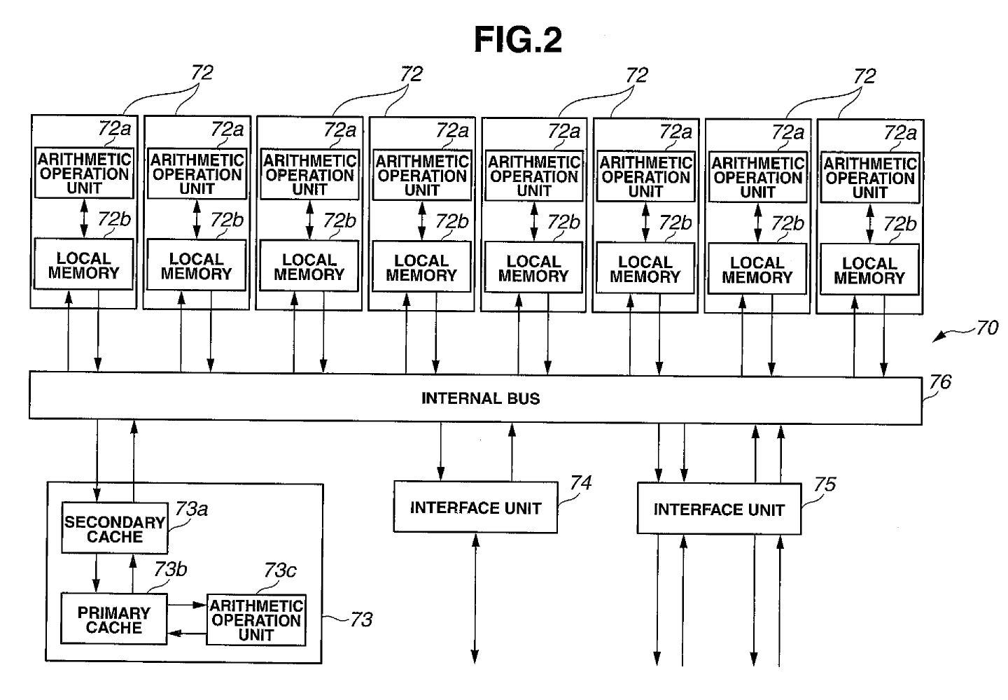

FIG. 2 is a block diagram showing a configuration example of the above-mentioned processors included in the display generation unit 11. A processor 70 has eight SPEs 72, a core CPU 73 as a parent processor, two interface units 74 and 75. The components are interconnected via an internal bus 76. Each of the SPEs 72 is configured including an arithmetic operation unit 72a as a coprocessor, and a local memory 72b. The local memory 72b is connected to the arithmetic operation unit 72a. A load instruction and a store instruction of the SPE 72 use a local address space to be stored in each local memory 72b, not the address space of the entire system so that the address spaces of the program executed by the arithmetic operation unit 72a cannot interfere with one another. The local memory 72b is connected to the internal bus 76. Using the DMA controller (not shown in the attached drawings) incorporated into each SPE 72, the software can schedule the data transfer to and from the main memory parallel to the execution of an instruction in the arithmetic operation unit 72a of the SPE 72.

The core CPU 73 includes secondary cache 73a, primary cache 73b, and an arithmetic operation unit 73c. The interface unit 74 is a DRAM interface of the two-channel XDR as a memory interface. The interface unit 75 is a Flex IO interface as a system interface.

Using a processor of a multi-core multiprocessor architecture capable of performing parallel processes, the parallel processes of generating, retrieving, displaying thumbnail images described later can be smoothly performed. The CPU can be not only a one-chip processor, but also plural combined processors.

### 3. Configuration of Input Device

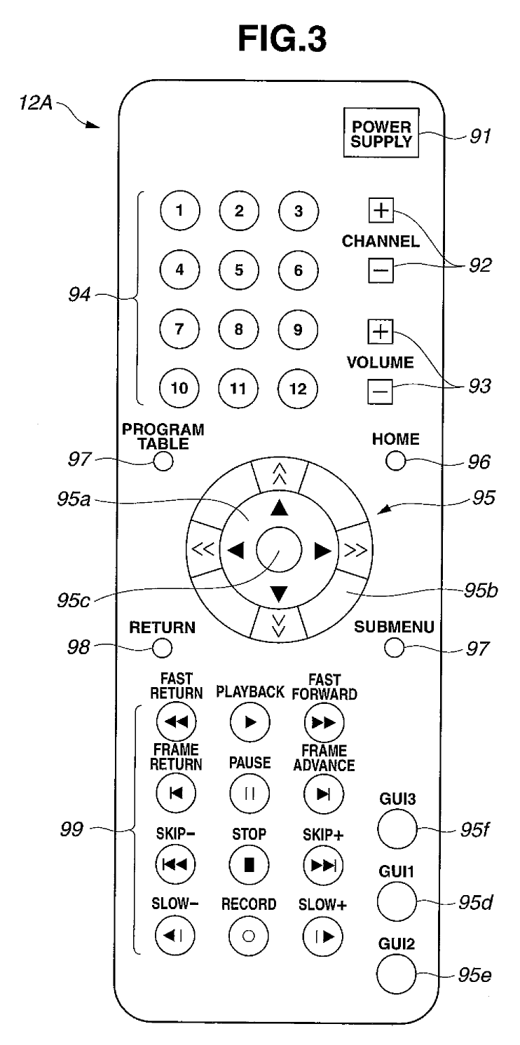

FIG. 3 shows a remote controller as an example of the input device 12. FIG. 3 is a plan view of a remote controller showing an example of the key array of a remote controller as the input device 12. On the surface of the remote controller 12A, plural buttons and keys that can be operated by a user with the fingers are arranged.

The remote controller 12A includes a power supply button 91, a channel button 92, a volume button 93, a channel direct switch button 94, a cross key 95 for moving a cursor up and down and right and left, a home button 96, a program table button 97, a submenu button 97, a return button 98, and a various recording and playback function key group 99.

The cross key 95 has double ring-shaped keys (hereinafter referred to as ring keys) 95a and 95b. Inside the inner ring key 95a, an execution key 95c for the function of selection, that is, execution, is provided.

Furthermore, the remote controller 12A includes a GUI1 button 95d and a GUI2 button 95e. The functions of the GUI1 button 95d and the GUI2 button 95e are described later. The remote controller 12A further includes a GUI3 button 95f, but the GUI3 button 95f is described with reference to the variation example described later.

In the following explanation, the input device 12 is the remote controller 12A shown in FIG. 3. A user can transmit various commands to the display generation unit 11 while operating the remote controller 12A on the display screen of the output device 13. The contents storage unit 10 accumulates each content, and a user can operate the input device 12, and retrieve and view desired contents. The display generation unit 11 executes various processes such as retrieving and displaying data according to a command from the remote controller 12A.

### 4. Data Structure of Contents Information

Described below is the information about the contents stored in the storage device 10A (animation contents in the present embodiment).

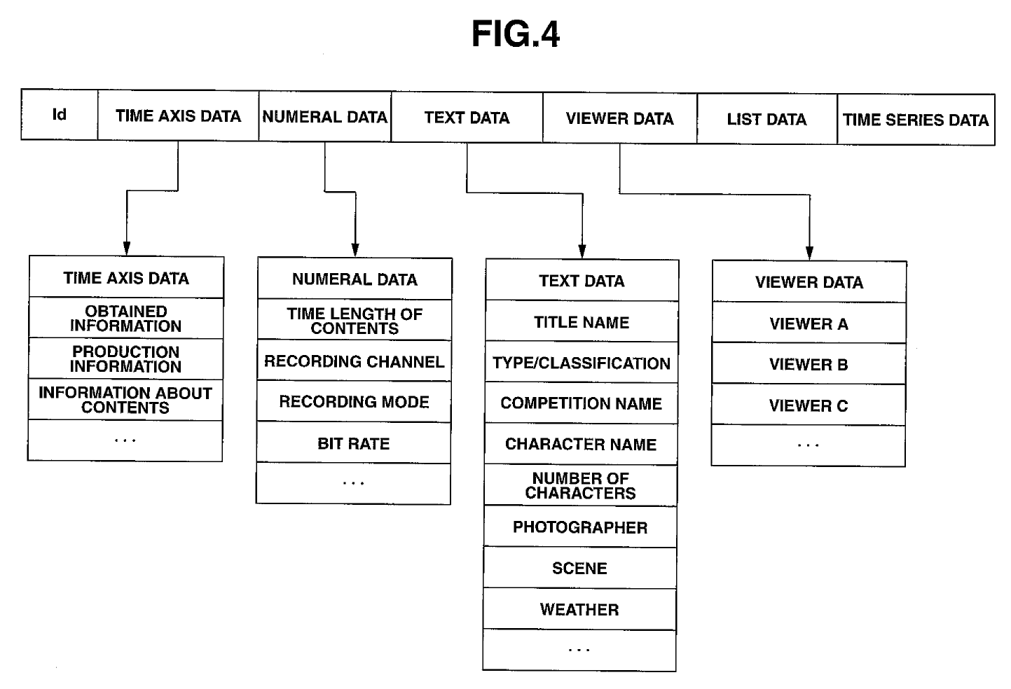

Each of the contents stored in the storage device 10A is assigned the contents information as shown in FIG. 4. FIGS. 4 to 8 are explanatory views of the data structure of the contents information assigned to each content.

The data structure shown in FIGS. 4 to 8 is an example according to the present embodiment, and the data structure has degrees of freedom. Therefore, as shown in FIGS. 4 to 8, configuring a hierarchical structure and structuring numeral data and text data can be realized in various structures. The data structures shown in FIGS. 4 to 8 are multi-layer hierarchical structures, but can be originally structured by one layer. The methods of structuring various data including numeral, text, link information, hierarchical structure, etc. are commonly known, and can be realized in the XML (extensible mark-up language) format. The data structure and recording format can be flexibly selected according to the mode of the video contents display apparatus 1.

As shown in FIG. 4, the contents information includes an ID, time axis data, numeral data, text data, viewer data, list data, and time series data. The contents information in FIGS. 4 to 8 is recorded on the storage device 10A.

The data shown in FIG. 4 is data in a table format, and each item includes data specified by a pointer. For example, time axis data includes data of acquisition information, production information, contents information, etc. Therefore, the contents information is the information in which each item is variable length data. Especially, the contents information has time information for each of plural time axes, and link information with the time series data.

In the data structure shown in FIG. 4, ID is an identification number as an identifier for uniquely designating video contents.

The details of the time axis data shown in FIG. 4 are described later.

The numeral data shown in FIG. 4 represents the characteristic of each Content data by numeric values. For example, the data refers to a time length of contents (the length of the contents in hours and minutes), and the channel etc. when the data is recorded. The numeral data includes information with bit rate settings in recording each content and the mode settings of equipment such as a recording mode (which voice channel is used in the two-language broadcast, or whether or not a program is recorded in a DVD compatible mode, etc.) registered as numeric values.

The text data shown in FIG. 4 is meta-information about a program provided by the title name of a program, and an EPG (electronic program). Since the data is provided as text data, the data is recorded as text data. After receiving a program, an intellectual analyzing operation such as an image recognizing process, a voice sound recognizing process, etc. is performed. Thus, a race name for a sport, the name of a character, the number of characters, etc. for a sport or drama, etc. are added and recorded as text data. Even when an automatic recognition cannot be performed in the image recognizing process, the voice sound recognizing process, etc., a user can separately input information in text, hereby recording text data. Furthermore, the data structure shown in FIGS. 4 to 8 can include data not provided by an EPG etc., not recognized in the image recognizing process, the voice sound recognizing process, etc., or not having input from a user. An item having no data can be blank, and the user can input necessary data as far as the data is necessary for fun for himself/herself. Since a photographer, a scene, the weather when a photo is taken, etc. can be useful information when the contents are taken by the user like a home video and when the contents are put in order or retrieved, the user can record the data as a part of text data.

Furthermore, as described later, in addition to persons who shares the contents, for example, if a friend can share the contents, the contents information for can be improved in cooperation, and a display screen can be obtained that is easy to use and easy to search/retrieve contents. Since a program distributed over a network includes common contents to be held by each user, a database of meta-data (contents information) of contents may be structured on a network server, such that friends or members of an indefinite number can write data to be shared.

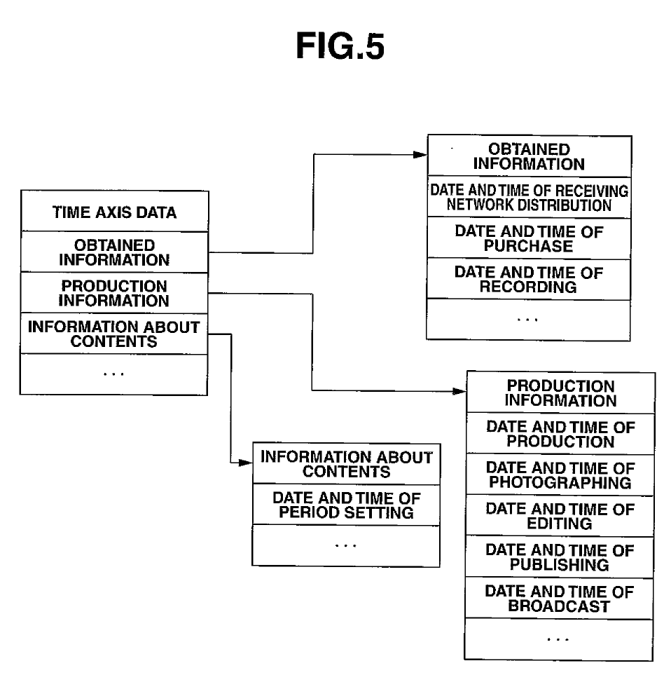

FIG. 5 is an explanatory view of the details of the time axis data shown in FIG. 4.

As shown in FIG. 5, the time axis data is furthermore hierarchically configured, and includes plural items of time axes classified into contents input information, contents production information, detailed information about contents, etc.

The acquisition information about contents varies depends on input means. For example, contents distributed over a network have date and time of recording as acquisition information. Toll contents in a network distribution format and a packet distribution format include a date and time of purchase as acquisition information. If a broadcast is recorded by a video recorder built in an HDD etc., the recorded data includes a date and time of recording as acquisition information. If the broadcast is recorded by a video recorder built in an HDD, the recorded data includes a date and time of recording as acquisition information. Thus, the acquisition information relates to the information about a time axis such as a date and time of download, a date and time of purchase, a date and time of recording, etc. As described later, the date and time can include a year, a month, a day, an hour, a minute, and a second, or can include only a year, only a year and a month without a minute and a second as a time indicating a period having a length in time. For example, if the time information such as period settings is oblique, or information indicates no time point but the information indicates a time length such as an event etc., a period data can be registered. If the time information is oblique or includes a time length, the date and time can be period data to be easily extracted when retrieved later. Therefore, in a time axis such as a period setting etc. the year of 1600 etc. does not indicate a momentary time point of 0:00 of Jan. 1, 1600, but indicates period data such as “0:00:00 of Jan. 1, 1600 to 23:59:59 of Dec. 31, 1600”. Furthermore, precise time data may not be acquired about a date and time of recording, a date and time of production, etc. In this case, the period data can be set so that data can be easily extracted when searched for.

The production information about contents is the information about a time axis such as a date and time of production, a date and time of shooting, a date and time of editing, a date and time of publishing (for example, for movie contents, a publishing date at theater, and for a DVD, a starting date of sales, etc.), a date and time of broadcast (the first date and time of broadcast, or the date and time of re-broadcast for a TV broadcast), etc.

The time axis information about the detailed contents can be, for example, the information about a time axis such as the date and time of a period set by the contents (for example, a date and time of the Edo period for a drama in the old days, and a date and time of the Heian period for the war between Genji and Heishi).

The time axis information includes the information (for example, a date and time of shooting) that cannot be acquired unless a contents provider or a contents mediator provides the information and the information that can be acquired by a contents viewer (contents consumer). There is also data for each content (for example, a date and time of recording from TV). The data for each content includes the data (for example, the first date and time of broadcast of the contents) to be shared with friends who hold the same contents.

That is, the contents information includes various data such as numeral data, text data, time axis data, viewer data described later, etc., of which the data to be shared can be shared using a network, and the data provided from a provider of the contents can be acquired and registered through a necessary path. If the data is not provided from the provider (for example, a date and time of shooting such as movie contents, etc.), the corresponding item is blank. If a viewer is to input the information, the viewer inputs the information. That is, various types of information are collected and registered as much as possible, and as the information is improved in quantity and quality, contents can be retrieved by various co-occurrence relationships, that is, the retrieval by association can be realized when the time is represented in plural dimensions (three dimensions in the following descriptions) as described later.

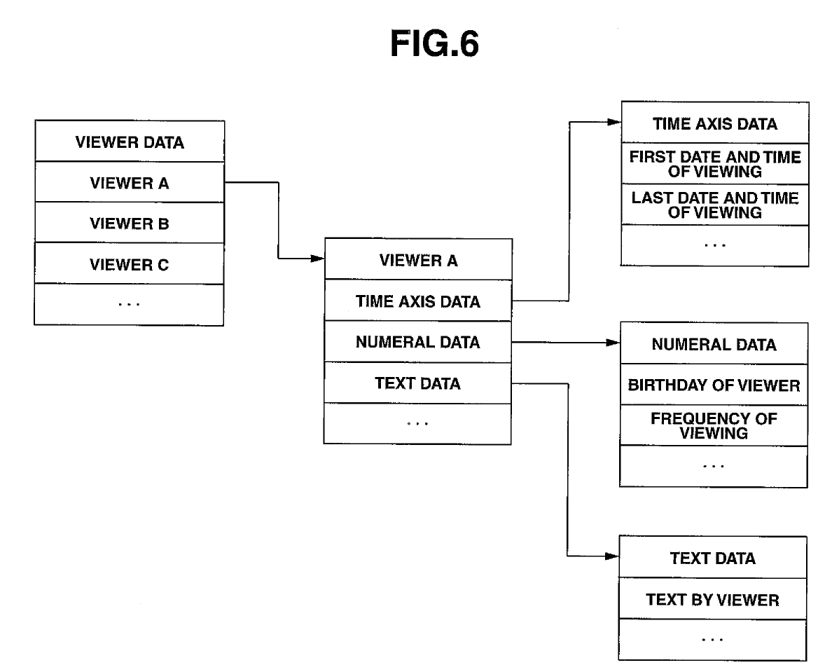

FIG. 6 is an explanatory view of the details of the viewer data. Each piece of viewer data in the viewer data includes time axis data, numeral data, text data, etc. The time axis data for each viewer includes the first date and time of viewing and the last date and time of viewing. Especially, if birthday data is recorded for each viewer, various time axis data of contents can be converted into a time calculated based on the birthday of the user not only by the absolute time, but also by performing a calculating process, thereby using the converted time in retrieving and displaying. The absolute time is a time with which an occurrence time of a life event of contents, for example, the occurrence time of each event such as birth, a change, contents, viewing, etc. can be uniquely designated. For example, it is a reference time based on which the year, month, day, hour, and minute can be indicated. That is, it is a time of a time axis for recording a life event of contents.

In other words, as time axis data, various time axes including (1) a time counter of contents, (2) a date and time of viewing of the contents, (3) a date and time of recording the contents, (4) a date and time of acquiring the contents, (5) a year or a date and time set by the contents or the scene, (6) a date and time of production of the contents, (7) a date and time of broadcast, (8) a time axis of the life of the user, etc. can be prepared.

Since the association (the consideration given when video contents are searched for based on the memory) of a person is performed along a time axis in many cases, and a considering method used when a person raises association or an idea is to use the relationships in various aspects and association, various types of time axes prepared allow a user to easily retrieve desired contents or scene.

Furthermore, if video contents are to be sorted using, for example, a type, a keyword to a character etc. as in the conventional method, one coordinate axis is not sufficient, and a coordinate value cannot be uniquely determined.

However, coordinates can be uniquely obtained by each video content using a time axis.

Therefore, preparing various time axes allows a user to retrieve contents with free association.

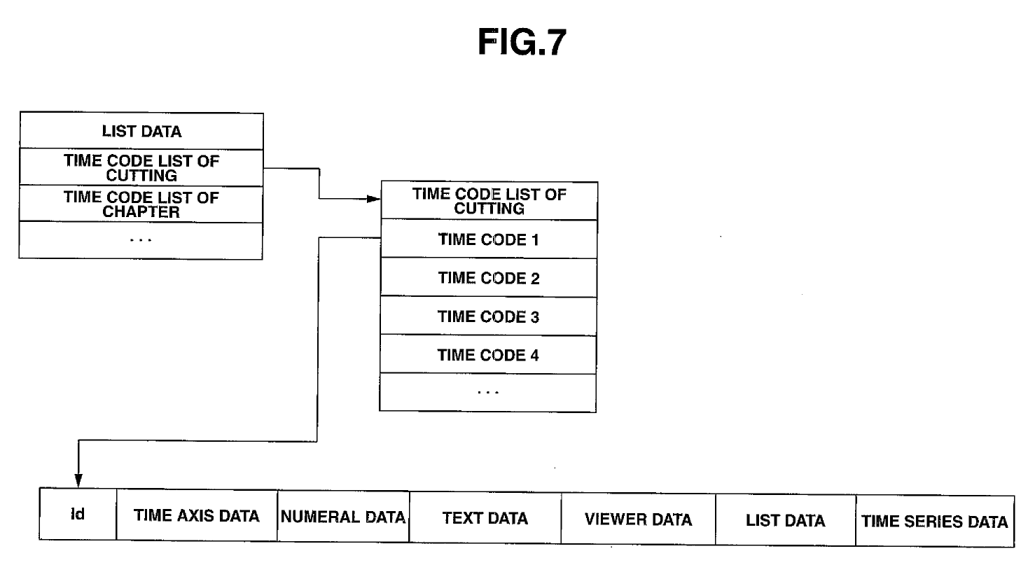

FIG. 7 is an explanatory view of the details of list data. The list data is a time code list for cutting, a time code list of chapters, etc., in contents. Since the cutting and the chapter can be regarded as contents of one unit, they recursively have the structures of the contents data shown in FIG. 4. However, the contents of “child” after division such as the cutting and the chapter inherit the contents information of “parent” (for example, the information about the date and time of purchase, the date and time of recording, the date and time of production, etc.).

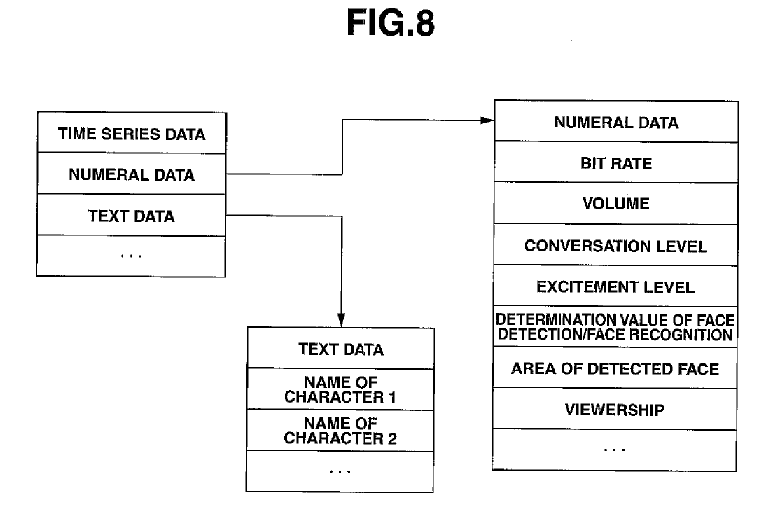

FIG. 8 is an explanatory view of the details of time series data. The time series data refers to time series data in contents, and the data that dynamically changes in the contents. The time series data is, for example, numeral data. The numeral data includes, for example, a bit rate, a volume level of an audio signal, the volume level of the conversation of a character in the contents, the excitement level in, for example, a football game program, the determination level when the face of a specific character is recognized, the area of a face image on the screen, the viewership in, for example, a broadcast program, etc. The time series data can be generated or obtained as a result of the audio and voice process, the image recognition process, and the retrieval process over a network. For example, the volume level of an audio signal, the volume level of conversation, the excitement level, etc. can be determined or assigned a level by identifying the BGM (background music), noise, and conversation voice in the audio or voice data process, measuring the volume of a predetermined sound, or analyzing a frequency characteristic in a time series. In addition, the determination value of face detection, face recognition rate, etc. can be obtained by numerical value of probability of the appearance of a specific character by numerical value of the size and position of a face in the image recognition process. The dynamic viewership data of a program can also be obtained from another device or another information source over a network. The time series data can be text data, and can be practically obtained as text data in an image process and a voice recognition process, and can be added to a data structure.

With the contents information having the data structures shown in FIGS. 4 to 8, plural contents is stored in the storage device 10A. The storage device 10A configures a time information storage unit for storing time information about the time axis of each content, and a time series information storage unit for storing the time series data of each content.

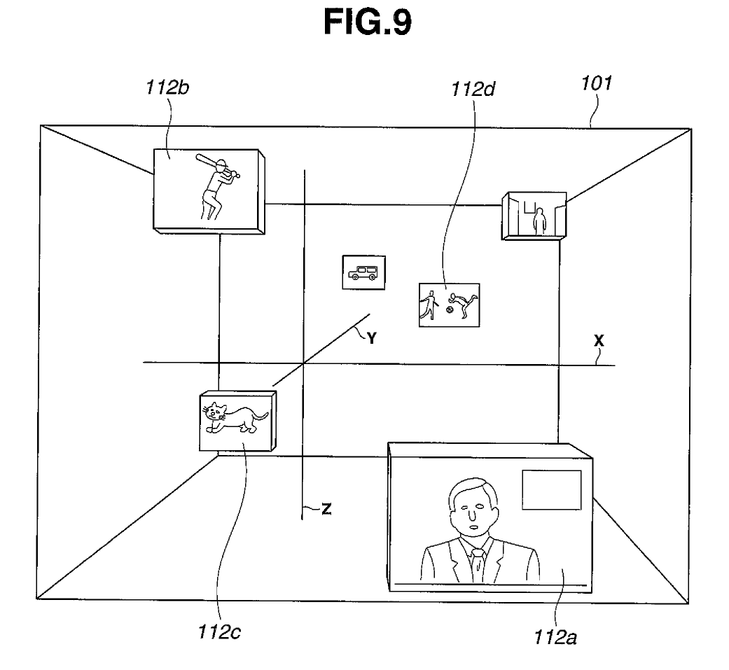

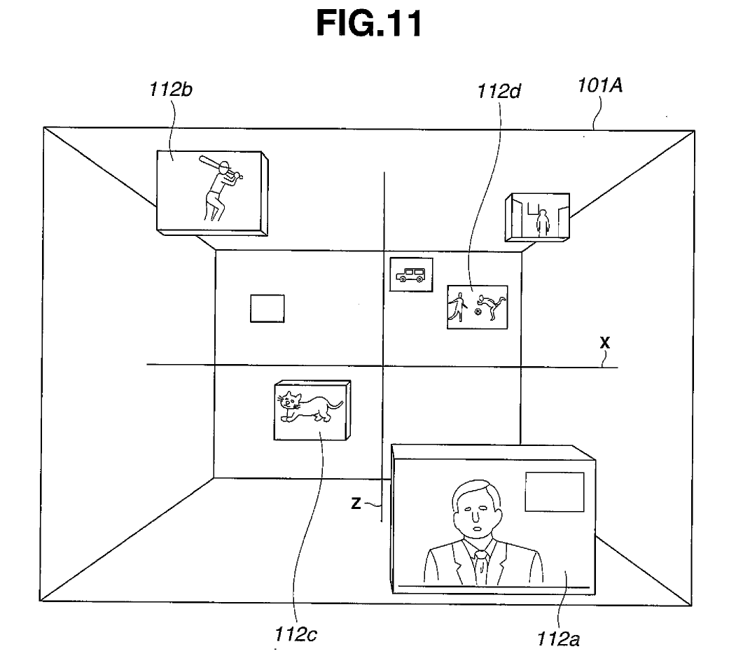

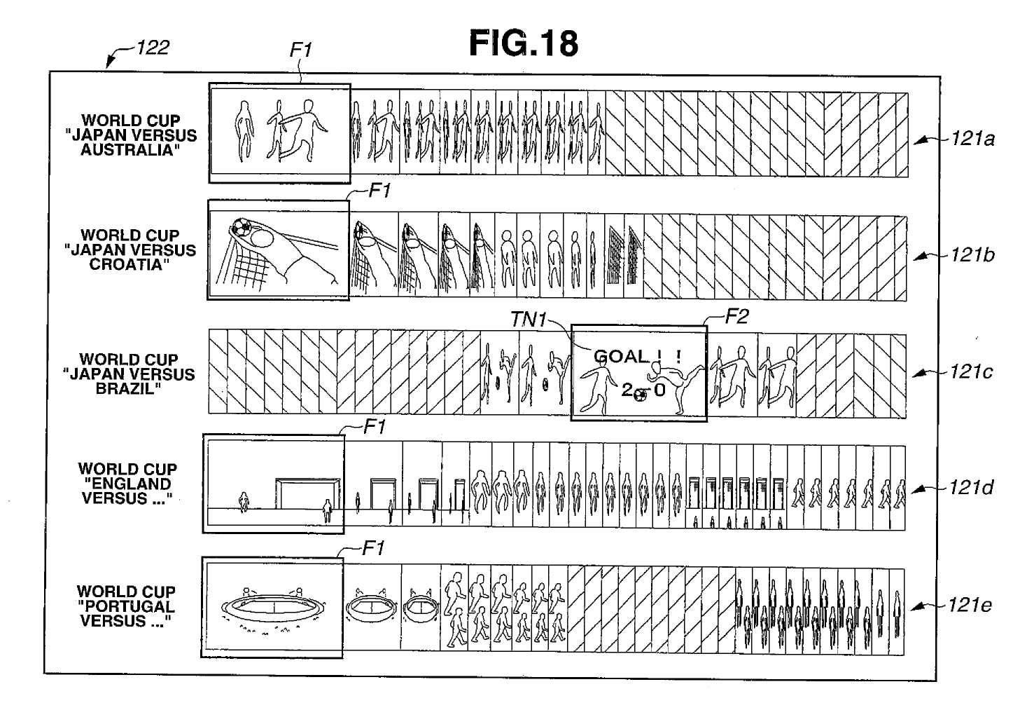

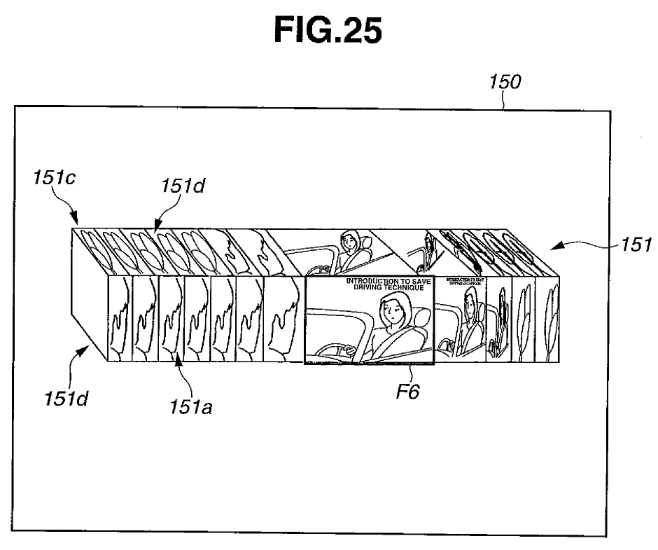

Using the plural contents stored in the storage device 10A and each of contents information about the plural contents, the video contents display apparatus 1 displays on the display screen of the output device 13 the three-dimensional display screen shown in FIGS. 9, 11, etc., and the image sequence display screen shown in FIGS. 18, 25, etc. described below. The display generation unit 11 generates each type of screen according to an instruction from the remote controller 12A, and displays a predetermined image on the screen of the output device 13.

### 5. Effect of Display Generation Unit

### 5.1 Display Example of GUI1

Described below is the effect of the video contents display apparatus 1 with the above-mentioned configuration.

First, the screen of the GUI1 as a three-dimensional display screen is described below. When viewing or having completely viewed a content, a user presses the GUI1 button 95d of the remote controller 12A, resulting in the screen shown in FIG. 9 to be displayed on the display screen of the output device 13. The GUI1 button 95d is an instruction portion to output a command to cause the display generation unit 11 to generate the information about the three-dimensional display screen indicating the state in which plural contents (or scenes) are arranged in a three-dimensional space as shown in, for example, FIG. 9, and perform the process of displaying a three-dimensional display screen according to the identification on the display screen of the output device 13.

FIG. 9 shows a three-dimensional display example of plural contents in a virtual space configured by three time axes in a predetermined display mode (block format in FIG. 9).

FIG. 9 is a display example of a screen in a three-dimensional display of a view space of a user (hereinafter referred to as a user view space) on the display screen of the output device 13 as, for example, a liquid crystal panel. On the display screen of the output device 13, an image obtained by projecting a three-dimensional image of a user view space generated by the display generation unit 11 on the two-dimensional plane viewed from a predetermined view point is displayed.

In FIG. 9, in a user view space 101 as a virtual three-dimensional space, plural blocks are displayed such that they can be arranged at a time position corresponding to each axis of three predetermined time axes. Each block indicates one content.

The size of each block shown in FIG. 9 has the same size in the user view space 101 of a three-dimensional space. However, a block closer to the view point of a user is displayed larger, and a block farther from the view point of the user is displayed smaller. For example, a block of one content 112a is closer to the view point of the user in the user view space 101, and is displayed larger, and a block of another content 112b is back to the content 112a, that is, farther from the view point of the user, and is displayed smaller. The size of each block can depend on the amount of each content, that is, the time length of the contents in the numeral data, in the three-dimensional user view space 101.

FIG. 9 shows a display example of a plurality of blocks each indicating one content as viewed from a predetermined view point with respect to the three time axes. In FIG. 9, the three time axes are predetermined as a first time axis (X axis) assigned a time axis of a date and time of production of contents, a second time axis (Y axis) assigned a time axis of a date and time of setting of a story, and a third time axis (Z axis) assigned a time axis of a date and time of recording of contents. Plural contents are arranged and displayed at the positions corresponding to the three time axes.

On the screen shown in FIG. 9, the name of a time axis may be displayed near each axis so that a user can recognize the time axis indicated by each axis.

Furthermore, whether or not each axis is displayed can be selected, or a ruler display (for example, a display of “the year of 1999 from this point”) can be added so that a user can determine the scale of each axis.

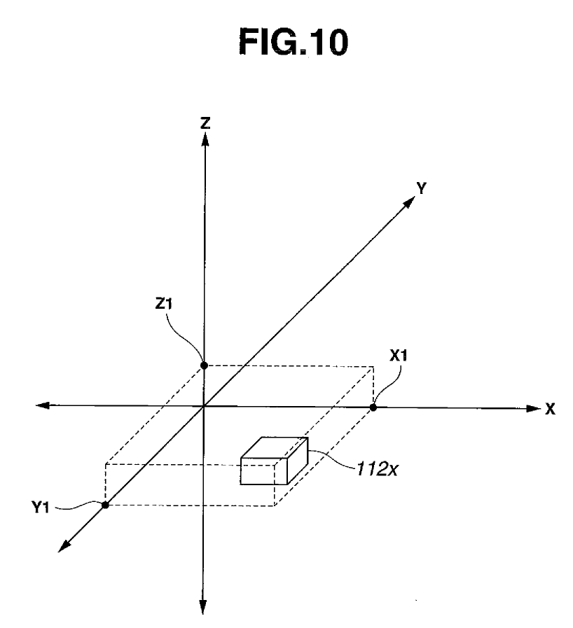

The arrangement of contents is described below with reference to FIG. 10. FIG. 10 is an explanatory view of the position relation between the three pieces of time axes and one content. As shown in FIG. 10, when the contents information about a content 112x includes production date/time data x1, period setting date/time data y1, and recording date/time data z1 as three pieces of time axis data, the block of the content 112a is arranged at a position (X1, Y1, Z1) as the central position in the three-dimensional space of the XYZ. The display generation unit 11 generates and output a projection image of the content 112a to display the block on the display screen of the output device 13 with the size and the shape as viewed from a predetermined view position.

Note that there may be such a case where, plural contents are positioned considerably far away on a time axis depending on a time axis such as a time axis for setting a period etc. In this case, a time axis scale can be, for example, a scale of a logarithm, and a scale can be changed such that the position of each content can correspond to each other. With the configuration, for example, the time density is higher for the time point closer to the current time, and the time density is lower for the time point closer to the past or the future.

In addition, when the date and time of setting a period is used, there is a tendency that certain period has a large volume of contents or few contents. For example, there are a number of contents from Nobunaga Oda to Ieyasu Tokugawa, but there are a decreasing number of contents in the stable Edo period. In this case, only the time order is held and the intervals of the plots of the axes can be set such that the arrangement of the contents can be equally displayed on the time axis.

Furthermore, some time axis data include only year data or year and month data without year-month-day data. In this case, the display generation unit 11 determines the time axis data for display of the GUI1 according to predetermined rules. For example, if the time axis data is “February in 2000”, the data is processed as the data of “Feb. 1, 2000”. According to such a rule, the display generation unit 11 can arrange each block.

In the display state shown in FIG. 9, a user can move a cursor to a desired content by operating, for example, the cross key of the remote controller 12A, and the contents can be put in a focus state. For each content being displayed, the time data of three time axes can be displayed near each content.

The content in the focus state is displayed in a different display mode from other contents to indicate the focus state by adding a yellow frame to the thumbnail images of the contents or increasing the brightness etc.

The view point of the screen shown in FIG. 9 may be changed such that the contents in the focus state is centered and displayed, or any point in the three-dimensional space may be a viewpoint position.

The movement (selection) of the focus contents, and the movement of the viewpoint position may be made up and down, left and right, backward and forward using the two ring keys 95a and 95b marked with arrows of the remote controller 12A.

Otherwise, the movements may also be made by displaying a submenu and selecting a moving direction from the submenu. Practically, by specifying two positive and negative directions of the axes (a total of six directions), the view point direction can be selected, thereby allowing a user to conveniently use the function.

In addition, the size of a user view space may be set in various methods. For example, the settings can be: 1) a predetermined time width (for example, three preceding or subsequent days) commonly for each axis, 2) different time axis for each axis (for example, three preceding or subsequent days for the X axis, five preceding or subsequent days for the Y axis, and three years for the Z axis), 3) a different scale for each axis (a linear scale for the X axis, a log scale for the Y axis, etc.), 4) the range in which a predetermined number (for example, 5) of preceding and subsequent contents including the focused contents for each axis are extracted (in this case, if plural contents are positioned close to each other, the range is smaller, and it they are positioned loosely, the range is larger), 5) the order of determining the range of each axis changeable when a predetermined number of contents are extracted including the focused contents for each axis (the range of the first axis can be amended when the range of the second axis is determined), and 6) only a sampled content displayable, or the size of the block indicating each content changeable when a predetermined number or more of contents exist.

As shown in FIG. 9, thumbnail images of a corresponding content can be applied to the side of the view point of each block. The thumbnail image can be a static image or animation. The user view space 101 displayed on the screen of the output device 13 can be generated as a projected image to the two-dimensional screen by setting a viewpoint position, a view direction, a viewing angle, etc. Furthermore, the title of a content can be displayed on or near the surface of each block.

FIG. 11 shows a display example of the user view space when the Y axis passes through the central point by changing the viewpoint position etc. FIG. 11 shows an example of a projection image to a two-dimensional space. In FIG. 11, since the Y axis passes through the central point, the Y axis is not visible to a user. In the case shown in FIG. 11, each content is expressed not as a block but as a thumbnail image, and each thumbnail image is the same in size, but displayed in a different size depending on the distance from the viewpoint position.

In FIGS. 9 and 11, if there are blocks having two or more contents overlapping when viewed from the viewpoint position, the thumbnail images in the back block can be viewed over the front block by setting a display state in which the front block before the back block can be displayed in a transparent state.

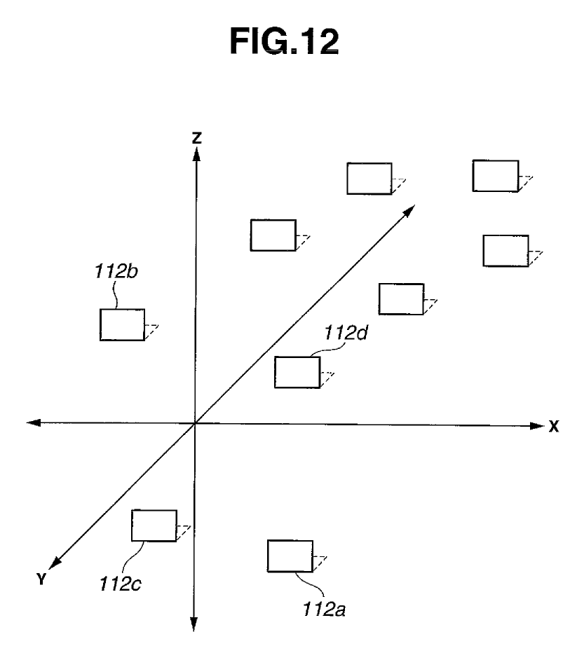

FIG. 12 is an explanatory view of the position relation between the contents in the display shown in FIG. 9 or 11. FIG. 12 is a perspective view of the three axes of X, Y, and Z when the axes are viewed from a predetermined viewpoint position. In the case shown in FIG. 12, a thumbnail image (thumbnail image can be a still image or animation) is assigned to each content so that, for example, the central position of the thumbnail image can correspond to a desired position. In FIG. 12, the surfaces of the thumbnail images face in the same direction.

The display generation unit 11 can generate the three-dimensional display screen shown in FIG. 9 or 11 by setting the viewpoint position, the view direction, and the viewing angle for the configuration of the three-dimensional space shown in FIG. 12. A user can operate the remote controller 12A to set the position of each time axis on the display screen as a desired position in a three-dimensional space, or to change various settings to change the view direction, etc.

Thus, by changing the viewpoint position, view direction, or viewing angle, a user can take a down shot of a contents group from a desired view point (viewpoint). In addition, if a time axis configuring a space is converted into another time axis, for example, a date and time of purchase of contents, then the user can easily retrieve contents, that is, search for the contents purchased in the same period.

In addition, for example, using as a reference position the date and time of the birthday of a user as a viewer, for example, an intersection position of three axes is specified, and plural contents are rearranged on each time axis. Then, the user compares the contents with the video contents taken by the user, and can easily search for a TV program frequently viewed around the time of the contents being recorded.

The origin position of time axis data, that is, the intersection of the three time axes, can be optionally set in each time axis. For example, in the case shown in FIG. 9, the data of the date and time of production (X axis), the date and time of period setting (Y axis) of the story, and the date and time of recording (Z axis) of the contents viewed by the user before pressing the GUI1 button 95d is the data of the origin position.

Furthermore, for example, in FIG. 12, since the date and time of period setting of a scene is the time axis in the front to back direction, that is, the Y axis, the static image and animation displayed as a set of contents and scenes are represented having no length in the front to back (depth) direction in FIG. 12. Nevertheless, depending on the time axis information indicated by a set of contents and scenes, the representation of the length in the front to back (depth) direction can be realized.

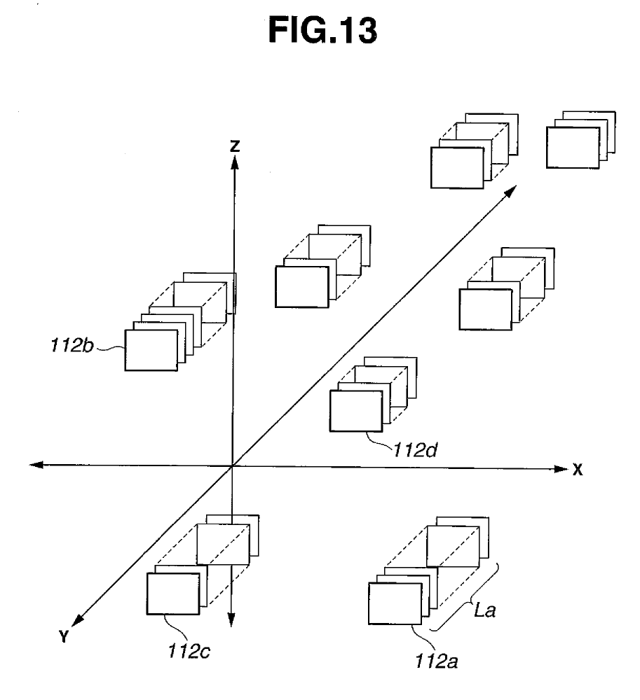

FIG. 13 shows a display example of representing a length in the front to back direction by the time axis information about each content. FIG. 13 shows a screen display example when a set of contents and scenes are three-dimensionally displayed when a user selects and sets the date and time of playing back and viewing contents, the elapsed time in the contents of scenes, the date and time of production of contents using the set of contents or scenes as a time axis of the three-dimensional space to be browsed or viewed. FIG. 13 shows a screen display example when the user sets the display from a predetermined view point by using the horizontal axis (X axis) as the date and time of playing back and viewing contents (date and time of viewing), the front to back (depth) axis (Y axis) as the elapsed time (time in a work, that is, a time code) in the contents of the scenes, and the up and down axis (Z axis) as the date and time of production of contents. In FIG. 13, for example, the content 112a is displayed as a set of images having the length La in the Y axis direction. As described above, the user can change the settings of the time such that the time of the three orthogonal time axes can be at a desired position in the three-dimensional space by operating the remote controller 12A.

In the example shown in FIG. 13, since the elapsed time (time in a work) in the contents of a scene is indicated by a front to back (depth) axis, the static image and animation displayed as the representation of a scene is the representation having the length of the video contents in the front to back (depth) direction. Nevertheless, as described above, depending on the time axis selected by a user, or the time information about a set of contents or scenes, the representation can have no length in the front to back (depth) direction.

In FIG. 13, when the thumbnail images of the contents arranged in a three-dimensional space are generated as projection images on the two-dimensional screen, the thumbnail images may be arranged to be in one direction in a three-dimensional space, for example, parallel to the Y axis, or may be arranged by changing the direction of the thumbnail images so that the thumbnail images faces the view direction.

Furthermore, by changing a time axis and a viewpoint position, the appearance of a two-dimensional projection image changes. At this time, the direction of the thumbnail images of each content may be fixed with respect to a predetermined time axis in a three-dimensional space. If the direction of the thumbnail image is fixed to a predetermined time axis in a three-dimensional space, the thumbnail image can be viewed at a tilt, or can be viewed from the back, thereby changing the view of the thumbnail image. Otherwise, even although time axis etc. is changed, the direction of a thumbnail image may be fixed on the two-dimensional projection image. For example, when an image is displayed in a two-dimensional array, a thumbnail image may be fixed to constantly face forward. In such a case where the direction of a thumbnail image of each content is fixed with respect to a predetermined time axis in a three-dimensional space, for example, by preparing a button of “changing a thumbnail image to face forward” for the input device 12, a user can change the direction of a thumbnail image with a desired state and timing.

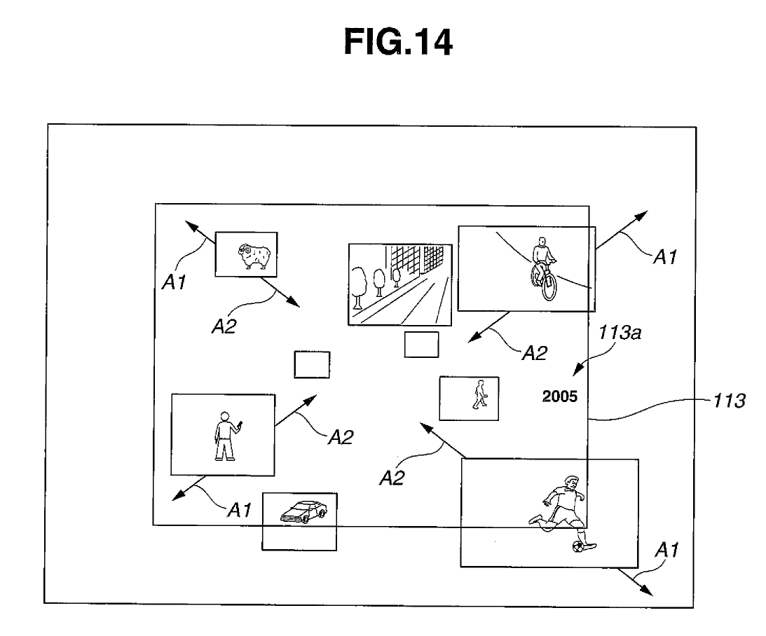

Furthermore, as a variation example of a display mode, the display method as shown in FIG. 14 can be used. FIG. 14 shows a screen display example when a set of contents and scenes is three-dimensionally displayed in case of video equipment such as a digital television.

FIG. 14 shows a state in which a user as a viewer selects a date and time of production of contents (date and time of production of a work), a date and time of setting a period of a scene (date and time of setting a story), date and time of recording contents and date and time of playing back and viewing of contents (date and time of recording and date and time of playback), as a time axis of a three-dimensional space viewing the set of contents or scenes while browsing, and browsing data in the resultant tree-dimensional space along the axis (in the depth direction) of the date and time of setting the period of scene (date and time of setting a story). The movement of a time axis of the date and time of setting a period can be made by a user operating a predetermined arrow key etc. of the remote controller 12A. When a view point moves along the time axis to trace back the time, each content is moved in the direction (radiated outward after continuously raising from the center of the screen) indicated by the arrow A1 in the screen shown in FIG. 14, and contents are continuously displayed from backward. On the other hand, when the view point is moved along the time axis such that the time can be close to the current point, each content is moved in the direction indicated by the arrow A2 (in the direction of converging to the center from the outside of the screen) on the screen shown in FIG. 14, and the contents continuously appear and are displayed from the surrounding areas. Thus, in FIG. 14, the animation indicating a set of contents and scenes corresponding to the operation of the remote controller 12A is shown to be three-dimensionally displayable. In FIG. 14, a rectangular frame 113 displayed at the center of the screen indicates the position of Jan. 1, 2005 at 00:00:00 in the time axis (front to back (depth) axis) of the date and time of setting the period of scene (date and time of setting a story). On the screen shown in FIG. 14, the year of “2005” is displayed by reference numeral 113a. Therefore, with the movement of the time axis of the date and time of setting a period, the frame 113 is also changed in size.

In the information about a time axis, the information about the first date and time of viewing by a user can be a blank if contents have not been viewed. When these contents are sorted by a time axis of the date and time of the first viewing, a future date and time are virtually set. For example, contents that have not been viewed can be arranged in a position of a predetermined time such as five minutes after the current time etc. If there are plural contents that have not been viewed, then the contents can be sorted by virtually setting the future date and time at equal intervals in the order of the activation date and time (date and time of purchase for package contents, date and time of reception for network received contents, date and time of recording for contents recorded from broadcasts, date and time of shooting for contents shot by a user).

5.2 Software of Display Generation Unit about GUI1

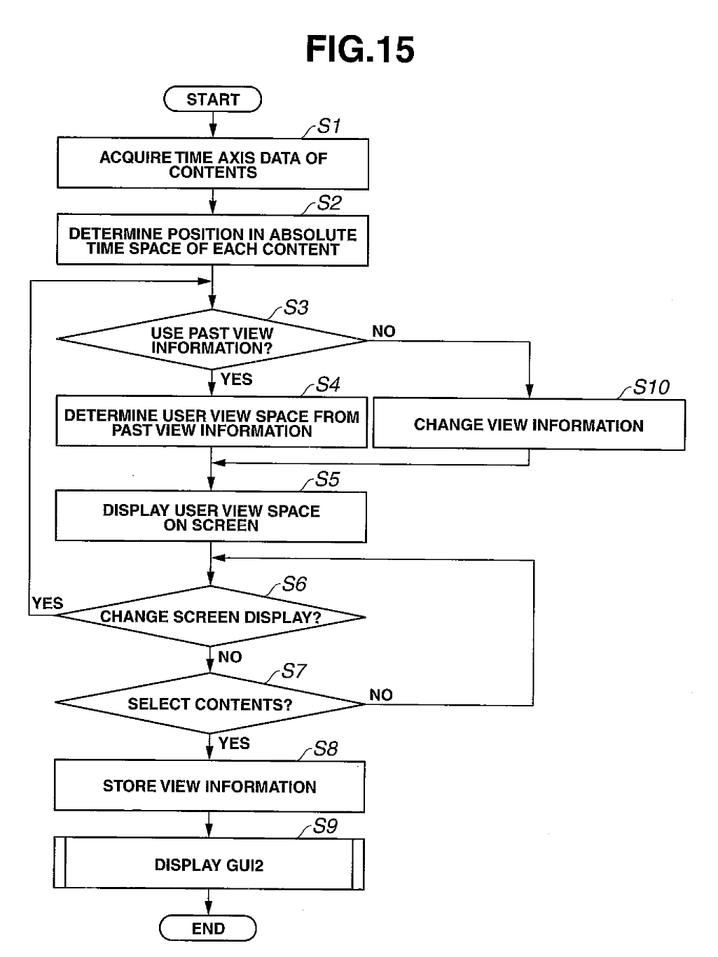

FIG. 15 is a flowchart of an example of the flow of the process of the display generation unit 11 to provide the display shown in FIG. 9, 11, 13, or 14 on the display screen of the output device 13. Described below is the case in which the screen shown in FIG. 9 is displayed.

When a user presses the GUI1 button 95d of the remote controller 12A, the display generation unit 11 performs the process shown in FIG. 15.

In the following example, the process shown in FIG. 15 is performed by a user pressing the GUI1 button 95d of the remote controller 12A, but the process shown in FIG. 15 may also be performed by the operation of selecting a predetermined function displayed on the screen of the output device 13.

First, the display generation unit 11 acquires time axis data of the contents information about plural contents stored in the storage device (step S1). Since the time axis information is stored in the storage device 10A as the time axis data about the contents information as shown in FIGS. 4 to 7, the time axis data is acquired.

The display generation unit 11 determines the position in the absolute time space of each content based on the acquired time axis data (step S2). The display generation unit 11 determines the position in the absolute time space, that is, the time, of each content for each time axis data. Thus, for each time axis, the position of the content on the time axis is determined for each time axis. The determined position information about each content on each time axis is stored on the RAM or the storage device 10A. The step S2 corresponds to a position determination unit for determining the position on plural time axes for each of the plural video contents according to the time information about the plural video contents.

Next, it is determined whether or not the past view information is to be used (step S3). The view information includes the information about the view point, the origin (intersection), three time axes, that is, the first to third time axes, and the display range of each time axis when the display shown in FIG. 9 is performed.

Whether or not the past view information is to be used may be set by a user in advance in the storage device 10A, and a display unit such as a subwindow etc. may be provided for selection on the display screen as to whether or not the past view information is to be used. A user makes the selection and determines whether or not the past view information is to be used.

If YES in step S8, that is, if the past view information is used, then the display generation unit 11 determines a user view space from the past view information (step S4).

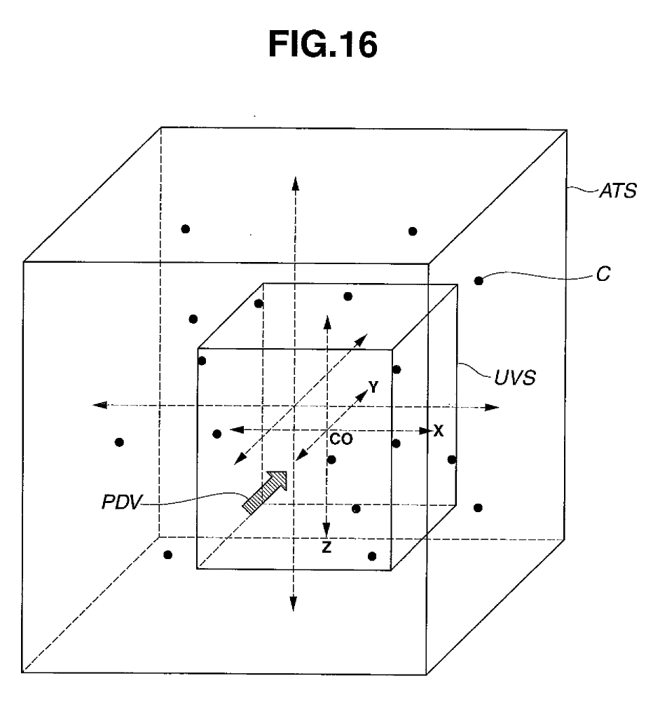

FIG. 16 is an explanatory view of the relationship between an absolute time space and a user view space.

In step S2, the position in the absolute time space ATS of each content C is determined. The user view space UVS is determined according to the set various types of information, that is, the information about the view point, the origin (intersection), three time axes, that is, the first to third time axes, and the display range of each time axis. The display generation unit 11 can generate the screen data (practically, the data of the projection image to the two-dimensional plane in the three-dimensional space) for display shown in FIG. 9 according to the information about the position in the absolute time space ATS of each content C determined in step S2, and the view information about the user view space UVS.

Thus, the display generation unit 11 displays the user view space on the screen of the output device 13 (step S5). The user view space includes the graphics of plural blocks indicating the respective contents. As a result, the display as shown in FIG. 9 is performed on the screen of the output device 13. In step S5, the video contents display unit displays, in a predetermined display mode, each of the plural video contents on the screen of the display device, according to the information about the position of each content, such that the contents correspond to the time axes of plural specified time axes, respectively.

Next, it is determined whether or not the user has selected a function of changing the screen display (step S6). When the function of changing screen display is displayed, for example, a user operates the remote controller 12A, displays a predetermined subwindow on the display screen, and a predetermined function for a change is selected.

If YES in step S6, that is, if a user issues an instruction to change screen display, control is returned to step S3. In step S3, it is determined whether or not the past view information is to be used. If the past view information is used (YES in step S3), and if there are plural pieces of past view information, then another piece of past view information is selected, or if the past view information is not used, a process of changing view information is performed (step S10).

If NO in step S6, that is, if a user does not issue an instruction to change screen display, it is determined whether or not a content has been selected (step S7). If a content is not selected, it is determined NO in step S7, and control is returned to step S6. A content is selected by a user using, for example, an arrow key of the remote controller 12A to move a cursor to the place of a content to be viewed and select the content.

If YES in step S7, that is, a content is selected, the display generation unit 11 stores the view information about a user view space displayed in step S5 in the storage device 10A (step S8). The view information includes a view point, an origin, a first time axis, a second time axis, and a third time axis, and further includes the information about a display range of each of the first to third time axes. As the information about a view point, for example, including the information as to whether the view point is positioned forward or backward the first to third time axes, the information about the origin is the information about the date and time such as a year, a month, etc. The information about the display range of each time axis includes scale information.

After step S8, the display generation unit 11 passes control to the GUI2 display processing (step S9). The transfer to the GUI display processing is performed by pressing the GUI2 button 95e.

If NO in step S3, that is, if the past view information is not used, view information change processing is performed (step S10). In the view information change processing, a subwindow screen (not shown in the attached drawings) is displayed to set each parameter on the display screen, to allow a user to set or input the information about the display range of the first to third time axes in addition to the above-mentioned view information, origin information, first time axis information, second time axis information, and third time axis information described above.

After the user changes the view information, control is passed to step S5, the user view space is displayed on the screen of the output device 13 according to the view information changed in step S10.

Thus, plural contents in a predetermined period of each of the three time axes are arranged in a three-dimensional array and displayed on the display screen of the display device of the output device 13. When the user requests to view one of the contents, the user selects the content, and the content is played back.

Since the video contents display apparatus 1 can display plural contents in relation to plural time axes as shown in FIGS. 9, 11, 13, and 14, the user can retrieve a content with the consideration of a person taken into account. That is, by displaying the above-mentioned plural time axes, the retrieval of a content can be performed to satisfy the request of the user with time specified to view “a content produced in the same period as the content viewed at that time”, “other video contents or scenes having the same background of the period as this scene”, or “a content broadcast when the specific content was previously viewed” with the time specified. Furthermore, for example, a request of a user to “retrieve the same content having the same period settings as the content viewed at the time when the content was purchased” can be satisfied.

As described above, when a user as a viewer selects three desired time axes from among plural time axes as an axis of the information about a three-dimensional space in which video contents or a scene in the video contents are browsed, the video contents display apparatus 1 configures a virtual three-dimensional space based on the selected time axes, and displays the video contents and the scene as a static image or animation at a predetermined position in the three-dimensional space according to the time axis information. By operating the remote controller 12A, the user can browse the space from any viewpoint position in the three-dimensional space. Then, the video contents display apparatus 1 can perform the viewing operation such as presenting, playing back, temporarily stopping the playback, stopping the playback, fast playing back, returning the playback, storing and calling a playback position, etc. of the information about the contents and the scene with respect to the set of the video contents and scene selected by the user from the display state on the screen shown in FIG. 9. Furthermore, the video contents display apparatus 1 can easily retrieve a desired scene by generating a GUI for retrieval of a scene as described later from the display state on the screen shown in FIG. 9.

In the conventional two-dimensional GUI, there are only two references (date and time of recording, last date and time of viewing) of represented rearrangements. Therefore, when the rearrangement reference is changed, it is necessary to press a page switch button or a mode change button.

Although there is a three-dimensional GUI for displaying video in a three-dimensional space, the GUI has no meaning, but has a three-dimensional appearance only.

In the conventional GUI, a content cannot be arranged on an evaluation axis when it is provided with various information such as a type name, the name of a character, a place, the meaning and contents of the content or scene. When the contents are arranged according to the information, each content may not be uniquely plotted.

However, using plural time axes as in the present embodiment above, a unique plot (assigning coordinates) can be allotted on each time axis. Therefore, it is effective to sort the animation content using a time axis.

Conventionally, a sorting method or a retrieving method using one or two types of axes (concept of time) such as a recording time, a playback time, etc. has been provided. The conventional sorting method etc. has no retrieval key such as the time of the date and time (Edo period if a drama of old days) set by the contents as described above, the date and time on which contents are published, the date and time of acquiring contents, the date and time of recording contents, etc. In the conventional sorting method, a user first selects a recording day from the listed contents, selects a recording channel, and selects a content, then a scene is retrieved. Thus, a content can be retrieved in the regular retrieving procedure.

However in the method above, in such a case where a scene can be recollected, but the recording day is oblique, it is difficult to select the scene.

In addition, for example, video contents cannot be practically performed at a request for “contents broadcast when the content is previously viewed”. The operation to allow a user having the request above to view the video contents can be performed by recollecting the date and time of the previous viewing of the current video contents, selecting each of the video contents from a list of plural video contents that can be viewed, comparing the date and time in an operation of displaying the date and time of broadcast, and repeating the operations until the video contents broadcast on the desired date and time can be retrieved. The more the video contents that can be viewed, the more impractical the above-mentioned operation becomes. Thus, most users give up the viewing.

However, a person vaguely remembers the co-occurrence relations and the relations between contents in various time axes, and may in some cases associate various time axes or co-occurrences with other contents while viewing contents. Conventionally, there is no method of retrieving and viewing contents based on the various time axes or co-occurrences. Then, there is no system etc. for providing a retrieving method using combined time axes such the GUI according to the present embodiment.

The three-dimensional GUI as shown in FIG. 9 described above can be used in searching for animation contents with the consideration of a person associated with plural time axes, and a user uses the GUI to retrieve desired animation contents or scenes based on various co-occurrence relations. Since each content is arranged in a virtual three-dimensional space and represented by a two-dimensional image, the user can select a desired content, move a cursor on the screen for the selection, and select a command on the screen using the two-dimensional image with high operability.

As shown in FIG. 9, according to the GUI of the present embodiment, a user view space can be represented by a three-dimensional display method using the three-dimensional axis of three time axes. Therefore, the user can walk through a virtual space, and enjoy browsing and viewing video contents with time specified. As a result, video contents can be easily retrieved by changing the sequence reference of plural displayed contents only by changing the view information such as a view point etc. without conventional buttons or waiting for switching of the screen.

That is, by the display shown in FIG. 9, the user can retrieve and view video contents depending on the user interest and various relations as if the user were playing surfing in a virtual space, thereby naturally and easily realizing the retrieving and viewing method on video contents.

As described above, according to the GUI1, the video contents or scene can be easily retrieved from plural video contents with the time relations taken into account.

### 5.3 Display Example of GUI2

Described next is the method of retrieving a scene in selected contents.

### 5.3.1 Retrieval of Related Contents

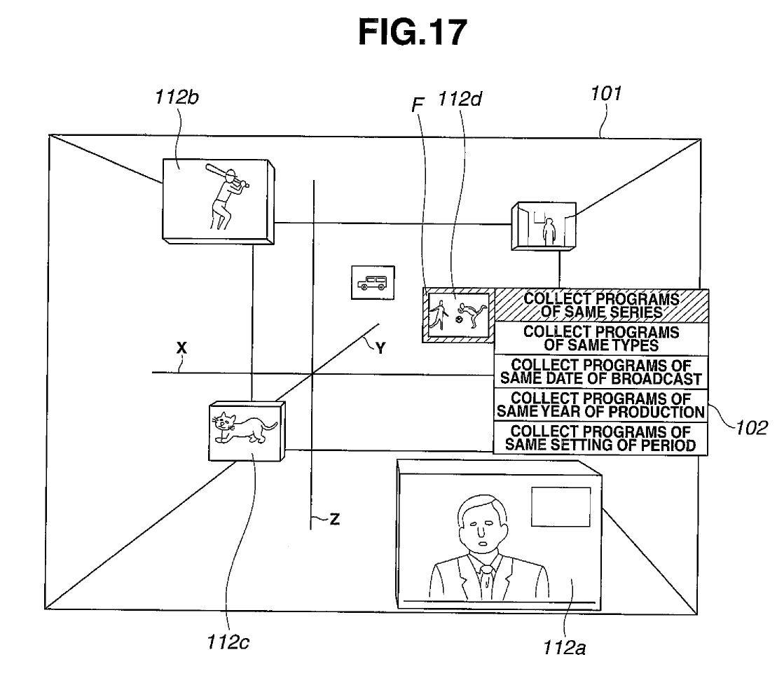

FIG. 17 shows the state of displaying a predetermined submenu by operating the remote controller 12A in the state in which the screen shown in FIG. 9 is displayed.

In the display state shown in FIG. 9, a user can operate the cross key of the remote controller 12A, move a cursor to a desired content, and set the content in a focus state. In FIG. 17, since the block of a content 112d is displayed added with the bold frame F indicating the selected state, the user can be informed that the block of the content 112d has been selected, that is, the block is in the focus state.

In the focus state, when a user operates the remote controller 12A and specifies the display of the submenu, a submenu window 102 as shown in FIG. 17 is pop-up displayed. The pop-up display of the submenu window 102 is executed as one of the functions of the display generation unit 11. The submenu window 102 includes plural selection portions corresponding to the respective predetermined commands. In the present embodiment, plural selection portions includes five selection portions, that is, the units for “collecting programs of the same series”, “collecting programs of the same type”, “collecting program of the sane broadcast day”, “collecting programs of the same production year”, and “collecting program of the same period setting”.

The user can operate, for example, the cross key of the remote controller 12A from plural selection portions, to move a cursor to desired selection portion to select a desired command.

FIG. 17 shows the state (indicated by diagonal lines) in which a selection portion of “collecting the programs of the same production year” is selected.

If the execution key 95c of the remote controller 12A is pressed in the state in which the selection portion (“collecting the programs of the same production year”) is selected, the programs of the same series as the selected content 112d are retrieved and extracted as related contents, and the screen as shown in FIG. 18 is displayed on the display screen of the output device 13.

FIG. 18 shows a display example of plural related contents retrieved on desired retrieval conditions in relation to the content selected in FIG. 9.

FIG. 18 shows five contents 121a to 121e. Each content is displayed with static images arranged in a predetermined direction, that is, displayed as a sequence of images arranged in the horizontal direction in this embodiment. In the five contents, the central content 121c is a selected content 112d selected in FIG. 17. The contents 121a, 121b, 121d, and 121e above and below are plural related contents retrieved and extracted by the display generation unit 11 as the programs in the same series as the content 112d. In the case shown in FIG. 18, the retrieval is performed by checking whether or not there is a content having the same title name as the selected content 112d in the title names of the contents information. FIG. 18 shows an example in which four contents having date and time of recording close to the date and time of recording of the content 112c are selected and displayed on the display screen. As shown in FIG. 18, the sequence of static images shows an accordion-shaped, bellows, or array-or-cards display mode.

In FIG. 18, the static images in a sequence of images of each content are reduced, practically compressed in the horizontal direction, and displayed along a predetermined path, that is, in the horizontal direction in this embodiment except one static image. The one static image not reduced in the horizontal direction is an image specified as a target image in the contents. The static image in each content is a thumbnail image described later according to the present embodiment. The predetermined path is a straight line in FIG. 18 and the following examples. But the predetermined path may be a curved line.

In the thumbnail images of the four contents 121a, 121b, 121d, and 121e, the leftmost thumbnail image is a target image not horizontally reduced. The frame F1 indicating a non-reduced image is added to the leftmost thumbnail image. The frame F1 is a mark indicating a target image not displayed as reduced in each content.

The thumbnail image in the central and selected content 121c is displayed in a state in which the leftmost thumbnail image is not reduced like other contents 121a, 121b, 121d, and 121e to which the frame F1 is added, and the frame F2 indicating the image at the cursor position is added when the screen shown in FIG. 18 is first displayed.

In the state above, when the user moves the cursor using the remote controller 12A, the thumbnail image (hereinafter referred to as a focus image) at a position (focus position) of the moved cursor is displayed in an unreduced state. FIG. 18 shows the state in which the cursor of the selected content 121c is moved from the leftmost, the thumbnail image TN1 at substantially the central portion is specified, the frame F2 is added, and the image is not reduced.

Note that the frames F1 and F2 are displayed in the display mode in which the frames can be discriminated from each other, for example, using different thicknesses, colors, etc. so that a target image can be discriminated from a focus image.

Further note that, in the explanation above, the method of displaying a target image is described such that an unreduced image is displayed. However, it is not essential to display an unreduced image, but any outstanding expression is acceptable.

The focus image shown in FIG. 18 is, for example, a thumbnail image TN1 of a goal scene of a football game. The position of a focus image indicates the position (time code for start of playback when the playback button is pressed) of a playback start point in a content.

FIG. 18 shows the contents 121a to 121e as a sequence of images of plural thumbnail images generated from plural framed images of each content. The display generation unit 11 retrieves a framed image from the image data of each content at the rate of, for example, one image every three minutes (3 min), generates and arranges each thumbnail image, thereby displaying the sequence of images of contents 121a to 121e. The time intervals of retrieving the images can be appropriately changed depending on the contents.

A target image and a focus image are displayed as reduced images simply with the image reduced in size without changing the aspect ratio. The thumbnail image at the positions other than the target image and the focus image are reduced in a predetermined direction, that is, horizontally reduced in this embodiment, and displayed as long portrait images.

As shown in FIG. 18, the images adjacent to or near the target image and the focus image can be displayed with the compression rate, that is, the reduction rate, set lower than those for other reduced images. That is, the reduction rate of two or three images before or after the target image or focus image is gradually increased (gradually reducing the image size) as the images are farther from the target image and the focus image, thereby allowing the images before and after the target image and the focus image to be more easily viewed by the user to some extent.

Furthermore, as the target image and the focus image, a target image may be displayed with higher brightness so that the target image can be brighter than the surrounding images. Otherwise, the thumbnail images other than the target image and the focus image may be displayed with lower brightness.

The image reducing direction may be a vertical direction in addition to the horizontal direction. The images may also be arranged and displayed by laying thumbnail images such that only the rightmost or leftmost edge can be viewed, instead of reducing the thumbnail images.

When the screen shown in FIG. 18 is displayed, the leftmost thumbnail image of each content is displayed in an unreduced state as a target image, but the rightmost thumbnail image can also be displayed in an unreduced state as a target image.

As described above, by arranging and displaying each content in a continuous sequence of plural static images in a predetermined direction, the user can browse a large flow of scenes in the entire contents, or roughly grasp the scene change. A user can determine a scene change by the position where the color of the entire sequence of static images has changed. In the sequence of images, if the time intervals of static images are arranged at equal intervals (equal interval mode), the user can immediately grasp the total length (length in time) of each content. The static images can also be arranged with the time interval of the static image set as unequal time intervals, and an arrangement (equal image number mode) of required number of images from the leftmost point to the rightmost point can be accepted. Otherwise, the reduction rate of static images may be changed with the total length of each content fixed, such that the time intervals of the static images are equal (equal total length mode).

As described later, the user can operate the remote controller 12A, and move the cursor position in the content, thereby changing the target image and the focus image. When thumbnail images are displayed in the equal interval mode, a target image or a focus image is skipped at predetermined time intervals, for example, every third minute. When thumbnail images are displayed in the equal image number mode, a predetermined rate, for example, 2% of the target image or the focus image of the content having any time length can be skipped.

As described above, in the present embodiment, the sequence of images of each content shown in FIG. 18 is displayed by plural thumbnail images generated by the display generation unit 11, but the display mode of the thumbnail images may be various other display modes. For example, the concept of scroll may be used. In this case, only the framed image of the portion of the length of the time or 30 minutes around the focus position is displayed as a sequence of thumbnail images in the screen width. However, by scrolling the screen, the thumbnail images of the portion other than the portion corresponding to the 30 minutes are sequentially displayed. In another method, the time intervals of the thumbnail images around the focus image, may be minutely set lengthening the time intervals with a farther position of the focus image, thereby setting the time intervals between the thumbnail images.

Back to FIG. 18, a display unit 122 indicating the same series or same program title is provided corresponding to each content on the left of FIG. 18.

In the display state shown in FIG. 18, a user can operate the remote controller 12A to select any thumbnail image of each content on the screen. Since the position of the focus image is a playback start point in a content, the user can play back and view the video in and after the selected thumbnail image by pressing the playback button of the remote controller 12A so that the content can be played back from the position of the selected thumbnail image.

As described above, the user can extract the desired content 112d from plural contents displayed on the three-dimensional display screen shown in FIG. 9, and extract and display the contents relating to the extracted content as shown in FIG. 8.

### 5.3.2 Retrieval of Related Scene

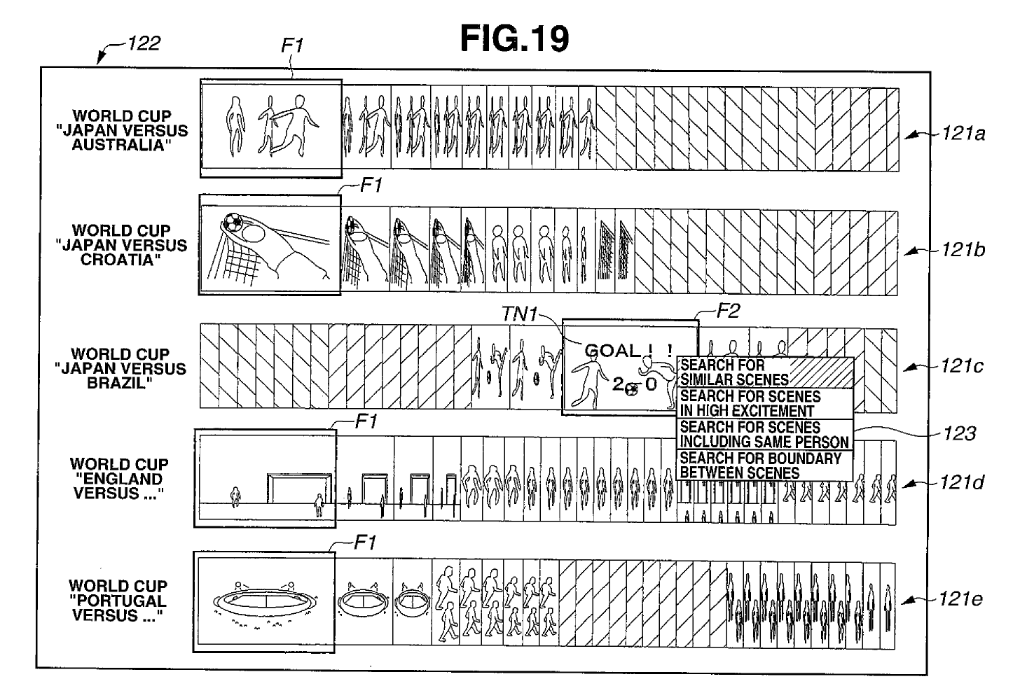

There is a case in which a user requests to retrieve a desired related scene associated with a scene in plural related contents as shown in FIG. 18. FIG. 19 shows the state in which the remote controller 12A is operated and a predetermined submenu for retrieval of a related scene is displayed in a state in which the screen shown in FIG. 18 is displayed.

A user can operate the cross key of the remote controller 12A in the display state shown in FIG. 18 and move a cursor to a desired thumbnail image. That is, the user can change a focus image. In FIG. 18, since a thumbnail image TN1 in the selected content 121c is displayed with a bold frame F2 indicating a selected state added, the user can be informed that the thumbnail image TN1 of the selected content 121c is selected and it is a focus image.

In the state, if the user operates the remote controller 12A and issues an instruction to display a submenu to retrieve the related scene, a submenu window 123 as shown in FIG. 19 is pop-up displayed. The submenu window 123 includes plural selection portions corresponding to the predetermined respective commands. In the present embodiment, the plural selection portions have four options, that is, “searching for a similar scene”, “searching for a scene of high excitementt”, “searching for a scene including the same person”, and “searching for the boundary between scenes”. The plural selection portions are command issue unit for retrieving a static image of a scene of a focus image and a related scene. The selection portion for “searching for a similar scene” is to retrieve a scene similar to the scene of the focus image. The selection portion for “searching for a scene of high excitement” is to retrieve a scene of high excitement before or after the scene of the focus image. The selection portion for “searching for a scene including the same person” is to retrieve a scene including the same person as the scene of the focus image. The selection portion for “searching for the boundary between scenes” is to retrieve the boundary between the scenes before and after the focus image.

A user can operate the cross key of the remote controller 12A, move a cursor to a desired selection portion from plural selection portions, and select a desired command.

FIG. 19 shows the state (indicated by diagonal lines) in which the selection portion for “searching for a similar scene” has been selected.

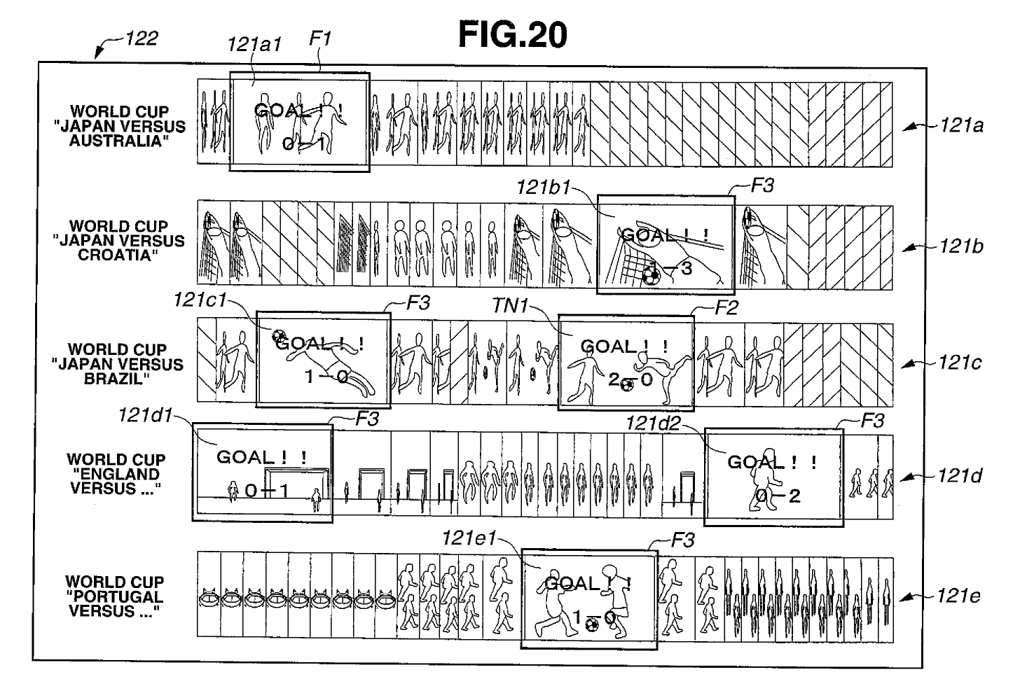

If the execution key 95c of the remote controller 12A is pressed in the state in which the selection portion (for “searching for a similar scene”) selected, then a scene similar to the scene indicated by the thumbnail image TN1 as a focus image is retrieved, and the screen as shown in FIG. 20 is displayed. FIG. 20 shows a display example of the related scene.

FIG. 20 shows, as scenes similar to the scene of the selected thumbnail image TN1, a thumbnail image 121a1 in the content 121a, a thumbnail image 121b1 in the content 121b, a thumbnail image 121c1 in the selected content 121c, thumbnail images 121d1 and 121d2 in the content 121d, and a thumbnail image 121e1 in the content 121e added with a bold frame F3 and in the unreduced display state.

A similar scene can be retrieved by analyzing each frame of each content or a thumbnail image, and by the presence/absence of (for example, characters similar to the those in the thumbnail image TN1) similar images.

A user can easily confirm the scene as a result of retrieval since an extracted related scene is displayed in an unreduced state as a result of retrieving a specified related scene as shown in FIG. 20. The user can play back and view the related scene by moving a cursor to the thumbnail image of the related scene and selecting the image, and operating the playback button. The above-mentioned example is to retrieve a similar scene from among plural contents. Since a scene corresponding to each of the commands “searching for a scene of high excitement”, “searching for a scene including the same person”, and “searching for the boundary between scenes” is retrieved, and the screen as shown in FIG. 20 is displayed, the user can easily retrieve a scene related to the focus image.

In response to the command for “searching for a scene of high excitement”, when the excitement level is proportional to the level of the volume included in the content, a scene having the high volume level is extracted. In response to the command for “searching for a scene including the same person”, the amount of feature is determined from an image of the face etc. of a person appearing in a specified thumbnail image in the image analyzing process, and an image having an equal or substantially equal amount of feature is extracted. In response to the command for “searching for the boundary between scenes”, an image having largely different amount of feature from an adjacent framed image is extracted in the image analyzing process.

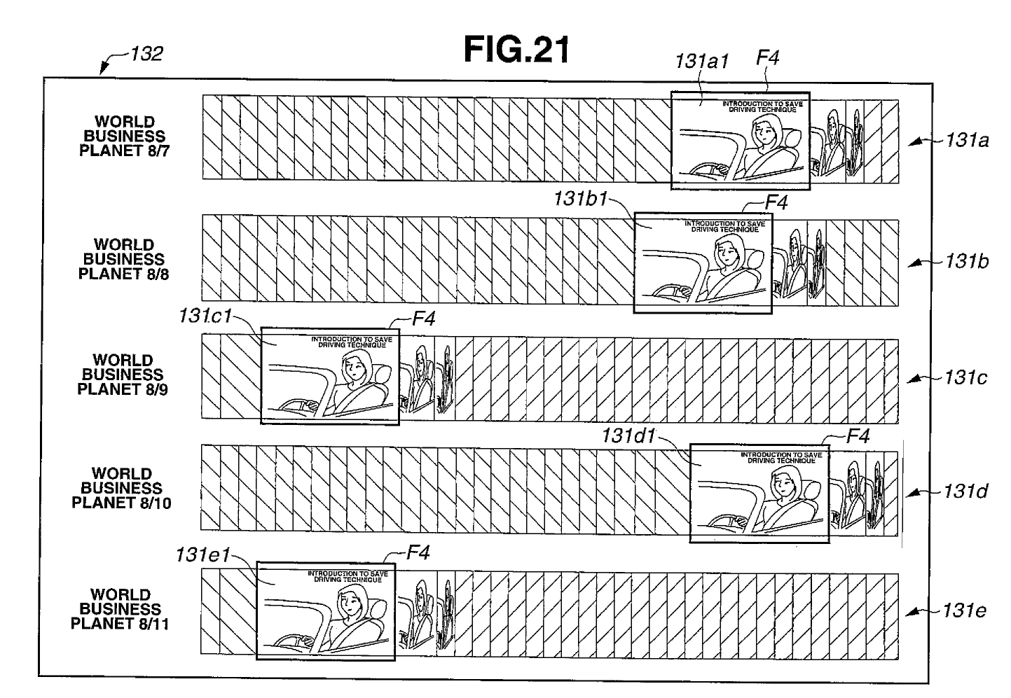

The above-mentioned example retrieves a similar scene etc., and an application example thereof can retrieve the same specific corner in the same program broadcast every day, week, or month. FIG. 21 shows an example of a screen on which a specific corner in a program broadcast every day. FIG. 21 shows five contents broadcast every day (in FIG. 21, the contents of the program titled “World Business Planet”) displayed as plural horizontally reduced thumbnail images in a tile arrangement.

FIG. 21 shows the display in which specific characters of, for example, “Introduction to the Safe Driving Technique” in a thumbnail image are detected in image processing with plural contents extracted as shown in FIG. 18 displayed as a sequence of images, and the first thumbnail image in the plural thumbnail images in which the characters are detected is unreduced and displayed. In this example, although not shown in the attached drawings, a window such as the submenu shown in FIG. 19 is displayed, and the characters to be retrieved can be input to the window, thereby acquiring the screen display shown in FIG. 21 from the state of the screen shown in FIG. 18.

FIG. 21 shows five contents 131a to 131e. In the contents, the detected thumbnail images 131a1 to 131e1 are displayed without reducing the first frame of the framed image in which the same characters are detected. The thumbnail images 131a1 to 131e1 displayed as unreduced are provided with a frame F4 indicating the detection. To the left of the five contents, a program name display unit 132 indicating the program name is provided.

In the description shown in FIG. 21, searching for the same specific corner in the same program is described by detecting the characters in the thumbnail image (or the framed image). However, when an image without a character is detected, a specific corner can be retrieved not in character recognition, but in image recognition processing.

Furthermore, in the voice sound processing, a corner starting with the “same music” can be retrieved. For example, a weather forecast corner can start with the same music. A corner appearing with the same superimposition mark can be retrieved. Although the superimposition is not read as a letter, it can be recognized as the “same mark”. In this case, the superimposition is recognized and retrieved as a mark. Furthermore, in the speech recognition processing, a corner starting with the “same words” can be retrieved. For example, when a corner starts with determined words “Here goes the corner of A”, the determined words are retrieved to retrieve the corner. Thus, if there are any common points in images or words as with the determined corner, then the common features can be retrieved.

### 5.3.3 Operation of Remote Controller and Change of Screen

### a) When Related Contents and Related Scenes are Fixed:

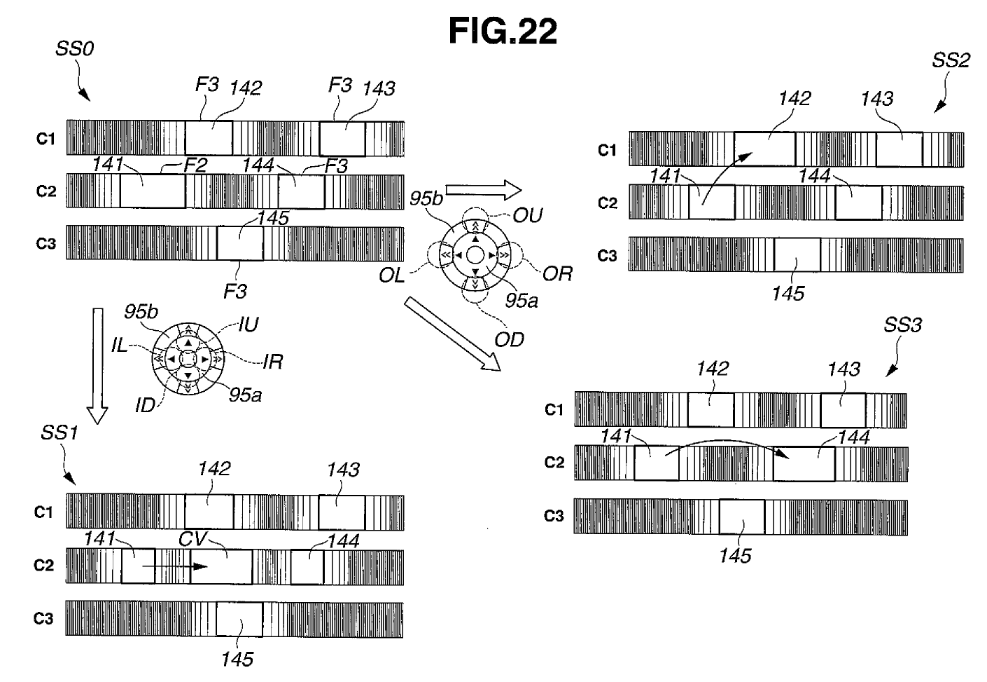

In the display state as shown in FIGS. 18 to 21, the relationship between the operation of the remote controller 12A and a change on screen is described below with reference to FIG. 22.

FIG. 22 is an explanatory view of the selection of a scene using the cross key 95 of the remote controller 12A in the screen on which a related scene is retrieved and displayed. For easier explanation, FIG. 22 shows the case in which three contents C1, C2, and C3 are displayed. The contents C1 and C3 are related contents, and the content C2 is a selected content.

In FIG. 22, in the initial display state SS0 of the three contents, a thumbnail image 141 as a focus image at the cursor position is provided with a bold frame F2. Other thumbnail images 142 to 145 are provided with bold frames F3 thinner than the bold frame F2. In this example, the thumbnail images 141 to 145 of the contents C1 to C3 are images of highlight scenes extracted as related scenes as shown in FIG. 20.

In the initial display state SS0, when the right cursor portion IR of the ring key 95a inside the cross key 95 is continuously pressed, the focus position is moved in the display state SS1 from the thumbnail image 141 to all right thumbnail images in the selected contents C2. At this time, while the right cursor portion IR is pressed, the thumbnail images at the cursor position are changed, and the focus image moves right without changing its size. In FIG. 22, the focus image moves along the arrow of the display state SS1, and the display in the bold frame F2 is a demonstrative animation using so-called flash software. When the left cursor portion IL is pressed, the focus image changes thumbnail image without changing the size, and the position of the focus image moves left.

Although not shown in the attached drawings, in the initial display state SS0, when the up or down cursor portion IU or ID of the ring key 95a is pressed, the focus image moves to the thumbnail image at the same position as the related content C1 or C3 above or below the cursor position regardless of a thumbnail image of a highlight scene.

Furthermore, if the movement of the focus image to the up or down related contents stops, and the right cursor portion IR is pressed from the position, the focus image moves right, and if the left cursor portion IL is pressed, the focus image moves left. That is, the left and right cursor portions IR and IL have the function of moving right or left the focus image, that is, in the same content. The up and down cursor portions IU and ID have the function of moving up and down the focus image, that is, between the contents.

Next, in the initial display state SS0, when the up cursor portion OU of the ring key 95b outside the cross key 95 is pressed, the focus moves to the thumbnail image 142 of the highlight scene of the related content C1 displayed above the thumbnail image 141 of the focus image in the selected content C2, thereby entering the display state SS2. If the up cursor portion OU is pressed, the cursor does not move from the thumbnail image 141 to 143 because the thumbnail image 142 is closest to the thumbnail image 141 on the display screen. If the cursor is placed at the thumbnail image 144 in the state shown in FIG. 22, and the up cursor portion OU is pressed, the cursor moves from the thumbnail image 144 to the thumbnail image 143.

Then, although not shown in the attached drawings, if the cursor portion OD is pressed in the initial display state SS0, the cursor moves to the thumbnail image 145 of the related content C3 displayed below.

If the cursor portion OD is pressed when the cursor is placed at the thumbnail image 142 of the related content C1, then the cursor moves to the thumbnail image 141 of the selected content C2 displayed below, and if the cursor portion OD is further pressed, then the cursor moves to the thumbnail image 145 of the related content C3 displayed below.

Similarly, if the cursor portion OU is pressed when the cursor is placed at the thumbnail image 145 of the related content C3, then the cursor moves to the thumbnail image 144 of the selected content C2 displayed above. If the cursor portion OU is further pressed, then the cursor moves to the thumbnail image 143 of the highlight scene in the related content C1 displayed above. That is, the up and down cursor portions OU and OD have the function of moving (that is, jumping) the cursor up and down, that is, between the contents, to the thumbnail image of the highlight scene.

In the initial display state SS0, if the right cursor portion OR of the ring key 95b outside the cross key 95 is pressed, then the cursor moves from the thumbnail image 141 of the highlight scene on which the cursor is placed in the selected content C2 to the thumbnail image 144 of the highlight scene of the selected content C2, thereby entering the display state SS3.

Then, in the display state SS3, when the left cursor portion OL is pressed, the cursor returns to the thumbnail image 141 of the highlight scene of the selected content C2. That is, the left and right cursor portions OR and OL have the function of moving (that is, jumping) the cursor left and right, that is, to the thumbnail image of the highlight scene in the same content.

As shown in the display example shown in FIGS. 18 to 21, plural contents vertically arranged can also be arranged such that the contents having the same program name in time series, thereby arranging a daily or weekly serial drama in time series, arranging only the “News at 19:00” in time series, or arranging the recorded matches of the same type of sports. By thus arranging the contents, such effects are obtained as, for example, it is facilitated to arrange the news at 19:00 in order to check the related news in time series focusing on a certain incidence, or to display broadcast baseball games in an array to collectively check the daily results.

### b) When Related Contents and Related Scenes are Dynamically Changed:

In the example above, on the screen on which the related scenes extracted and specified in the submenu window 123 shown in FIG. 19 are displayed, a highlight scene changes corresponding to the operation of the remote controller 12A.

The display generation unit 11 has change the related contents displayed with the selected contents, according to the contents of focus images or contents information. For example, when the focus image displays the face of a talent of a comedy program, the contents of a program in which the talent plays a role are extracted and displayed as related contents. Otherwise, when a focus image displays the face of a player in a live broadcast of a golf tournament, the contents of a program in which the player plays a role are extracted and displayed as related contents. Furthermore, when a focus image displays a goal scene of a team in a football game, the contents of a program in which the team has a goal scene are extracted and displayed, etc.

Furthermore, in the displayed selected contents and the related contents, the scenes in which the same talent or the same player is displayed are displayed as related scenes. In the display state, the operation by the cross key 95 as shown in FIG. 22 can be performed.

In such a display state, the function may be suppressed by selecting whether or not the function of the outside ring key 95b is made effective.

In addition, with a change of the focus image, related contents may be dynamically changed, and related scenes may also be dynamically changed.

Furthermore, there may be a switching function between enabling aid disabling the function of dynamically changing related contents with a change of the focus image, and in addition, there may be a switching function between enabling and disabling the function of dynamically changing related scenes.

Furthermore, if the image of the weather forecast corner in a news program is a focus image, the related contents above and below are displayed as including the images of similar weather forecast corner in another program as a target image. A user can perform an operation of moving only the image of the weather forecast corner by moving the focus up and down. Otherwise, if a close-up of a talent in a drama is a focus image, the related contents above and below are displayed as associated with a close-up of the same talent in another program as a target image. When the user moves up and down the focus, a target image of a close-up of the same talent in another program can be displayed.

If related scenes are dynamically changed depending on the movement of the focus image, then the display generation unit 11 can perform a process of generating list data of the cast in the program in the background process, thereby more quickly performing dynamic change and display processing.

Thus, if related contents can be dynamically changed according to the contents of a focus image or the contents information, the related scene of the changed related contents can be retrieved.

Therefore, a user as a viewer can easily retrieve a screen or enjoy retrieving a scene.

In addition, if animation contents are a set of cuts and chapters, the cuts and chapters in the contents can be regarded as a unit of contents as well as the original contents. In this case, if the cuts and chapters are designed to have the structure of content data as shown in FIGS. 4 to 8 recursively, then an effect different from the arrangement in a recorded unit (of a program) can be obtained.

That is, depending on the position of the cursor or a so-called focus image, the contents information included in each content changes. Therefore, for example, the related contents arranged up and down can be more dynamically changed depending on the movement of the position of the focus image on the thumbnail images as shown in FIG. 21.

When the related contents arranged up and down are dynamically changed, for example, the following display can be performed.

1) Programs of other channels at the same recording time are arranged in order of channels.
2) Same programs (daily or weekly recorded) are arranged in order of recording time.
3) Same corners (for example, a weather forecast, a today's stock market, etc.) are arranged in order of date.
4) Programs with the same cast are arranged in order of time regardless of the titles of programs.
5) Contents captured at the same place are arranged in order of time.
6) Contents of the same type of sports are arranged in order of time.
7) Same situations and same scenes (chances, pinches, goal scenes) of the same type of sports are arranged in order of time.
8) The contents arranged above and below are not only the same in contents information, but also, for example, different in scene in sports such as the first goal scene, the second goal scene, the third goal, etc. in the same contents arranged in order based on a specific condition.

In the example in (8) above, in the case of the contents of sports, the same type of sports are arranged, the same type of sports with chance scenes are arranged. Thus, if there are plural methods of arranging scenes, then a system of specifying the arranging method can be incorporated into a context menu of the GUI.

### 5.3.4 Variation of GUI2

### a) First Variation Example

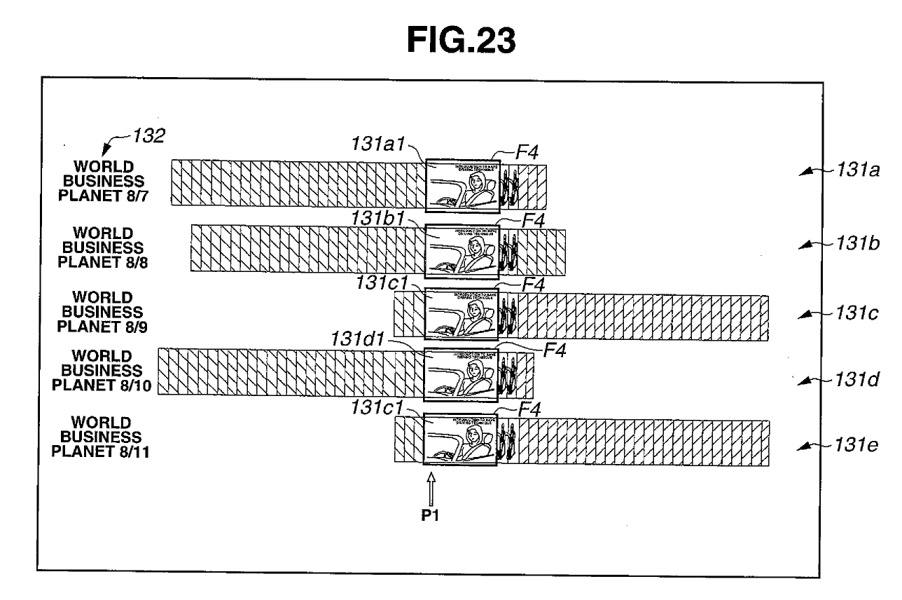

FIG. 23 shows a variation example of the screen shown in FIG. 21. As shown in FIG. 23, a sequence of images may be arranged such that the detected scene, for example, the framed image of the same corner can be in a predetermined direction on the screen, in this example, in the position P1 in the vertical direction.

Furthermore, as one method of using a sequence of images, there are fast forward and fast return bars in playing back contents.

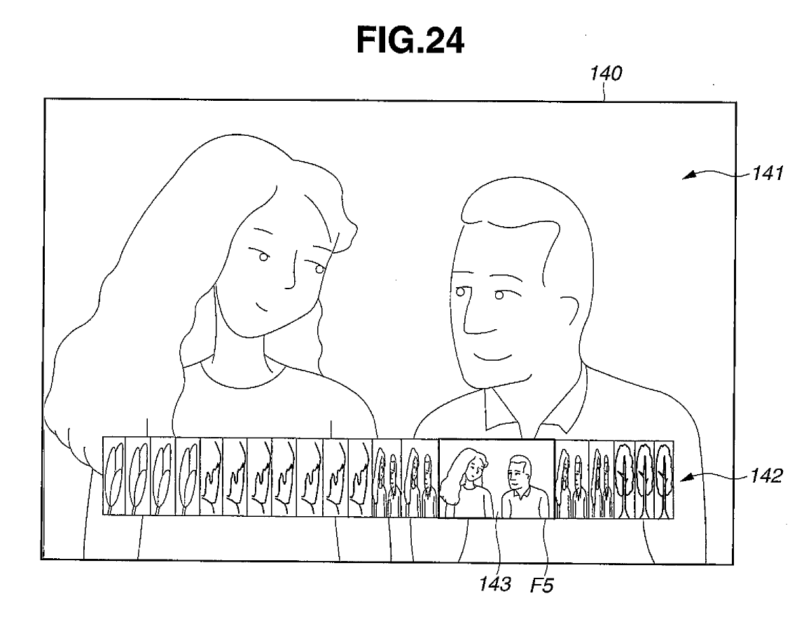

FIG. 24 shows a display example of a sequence of images as fast forward and fast return bars displayed on the screen. On the screen, a scene display unit 140 for displaying a scene being played back is included. In addition to a scene 141 being played back in the display contents, an image sequence display unit 142 indicating the entire contents is provided on the screen. The image sequence display unit 142 displays the thumbnail image display unit 143 corresponding to the scene 141 added with a frame F5 as a cursor position. The scene 141 as a background image corresponds to the thumbnail image at the cursor position of the image sequence display unit 142.

While playing back contents, the thumbnail image corresponding to the scene 141 being played back is displayed on the thumbnail image display unit 143, but if the user operates the remote controller 12A, and moves the cursor position of the image sequence display unit 142, then the display generation unit 11 displays the thumbnail image corresponding to the moved position on the thumbnail image display unit 143, and displays on the scene display unit 140 the scene 141 of the contents corresponding to the position displayed on the thumbnail image display unit 143. What is called a fast forward or fast return is realized by the image sequence display unit 142 and a cursor moving operation.

### b) Second Variation Example

FIGS. 25 to 27 show another variation example of the screen shown in FIG. 21.

FIG. 25 shows a variation example of a display format for display of each sequence of images corresponding to four contents on the four surfaces of a tetrahedron. A screen 150 displays as a perspective view a long tetrahedron 151 viewed from a view point on the display screen of the output device 13. Surfaces 151a to 151d of the tetrahedron 151, that is, a long pillar, are respectively provided with four sequences of images of the contents 131a to 131d shown in FIG. 21. In FIG. 25, the tetrahedron 151 is viewed from a view point. Therefore, the surfaces 151a and 151b have the sequence of images of the contents 131a and 131b.

The user can rotate the tetrahedron 151 in a virtual space and change the surface viewed from the user by operating the cross key 95 of the remote controller 12A. For example, when the up cursor portion OU of the outside ring key 95b is pressed, the tetrahedron 151 rotates so that the surface 151d can be viewed from the front in place of the surface 151a which has been viewed from the front up to this point. As a result, the user can view the sequence of images of the contents 131d. Furthermore, when the up cursor portion OU of the outside ring key 95b is pressed, the tetrahedron 151 rotates so that the surface 151c can be viewed from the front in place of the 151d which has been viewed from the front up to this point. As a result, the user can view the sequence of images of the contents 131c.

On the other hand, when the down cursor portion OD of the outside ring key 95b is pressed, the tetrahedron 151 rotates so that the surface 151b can be viewed from the front in place of the surface 151a which has been viewed from the front up to this point. As a result, the user can view the sequence of images of the contents 131b. Furthermore, when the down cursor portion OD of the outside ring key 95b is pressed, the tetrahedron 151 rotates so that the surface 151c can be viewed from the front in place of the surface 151b which has been viewed from the front up to this point. As a result, the user can view the sequence of images of the contents 131c. As described above, the user can operate the remote controller 12A, and switch the displayed sequence of images so that the tetrahedron 151 can be rotated like a cylinder.

The operation of moving the highlight scene shown in FIG. 25 can be performed by the user with the remote controller 12A in the same method as described above with reference to FIG. 22. The tetrahedron shown in FIG. 25 may be displayed so that the position of the thumbnail image of the highlight scene can be the same position as in the vertical direction as shown in FIG. 23.

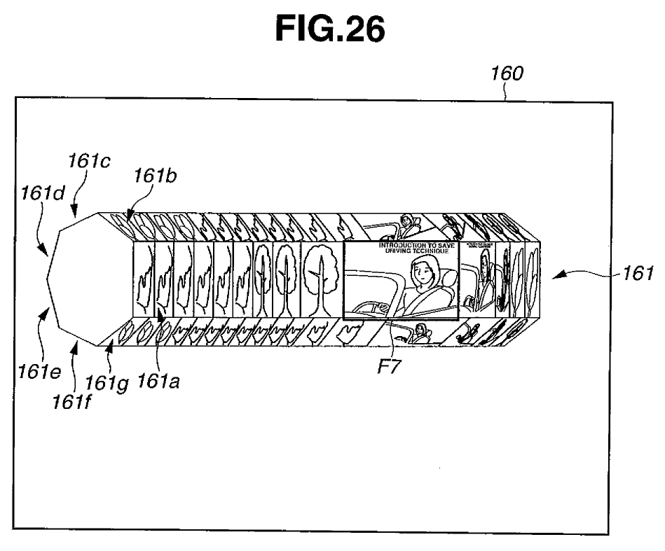

FIG. 26 shows a variation example of displaying a sequence of images using a heptahedron 161 in place of the tetrahedron shown in FIG. 25. FIG. 26 is different from FIG. 25 only in that the tetrahedron is replaced with the heptahedron, but the display method, the operation method, etc. are the same. A heptahedron enables, for example, a daily broadcast program to be display on the heptahedron 161 collectively for one week, a daily broadcast program to be recorded, a specific scene to be retrieved and displayed on the screen as shown in FIG. 26, and sequence of images of seven programs from Sunday to Saturday to be applied to seven surfaces 161a to 161f of the heptahedron 161.

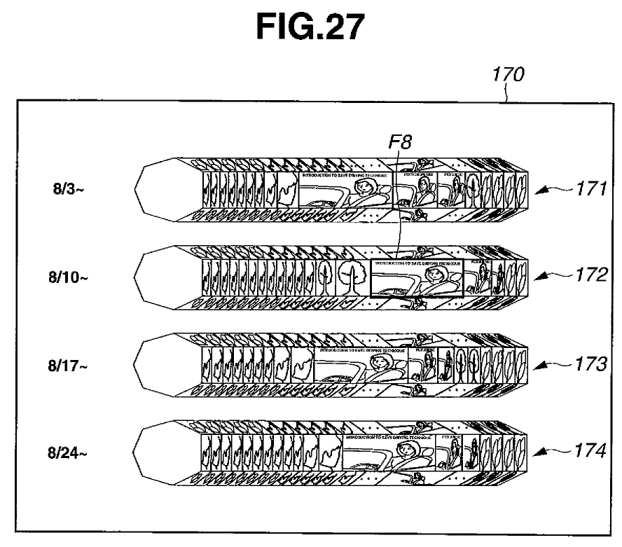

FIG. 27 shows a display example of displaying four heptahedrons shown in FIG. 26. A screen 170 displays four heptahedrons 171 to 174. When contents are recorded every day, and four heptahedrons 171 to 174 are displayed on the screen 170, the contents for about one month (for four weeks correctly) can be collectively displayed. Therefore, the user can view the recorded 1-month program. Especially, the display example in FIG. 27 clearly shows a list of sequence of images above and below.

In the display state shown in FIGS. 25 to 27, the scenes related to the focus image can be selected by retrieving a scene similar to the focus image, thereby allowing a user to easily retrieve and even enjoy retrieving related scenes.

### c) Third Variation Example

Furthermore, as a variation example of the displays shown in FIGS. 18 to 27, the magnification or reduction of thumbnail images can be controlled to present additional information other than the time flow of the contents.

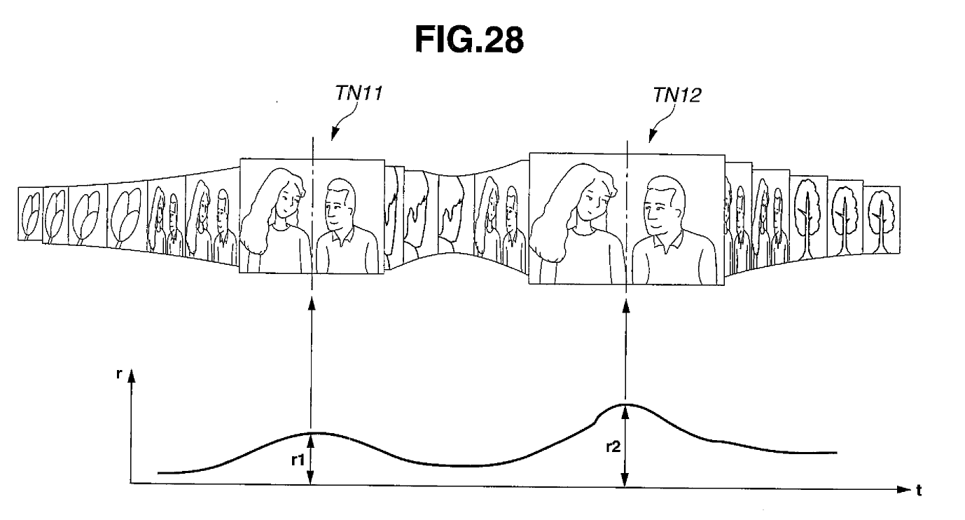

FIG. 28 is an explanatory view of the display example of changing the size of each thumbnail image in the sequence of images depending on the time series data, for example, the viewership data, in this embodiment.

The viewership data r of the contents changes corresponding to the elapsed time t of the playback time of contents. With the change, the thumbnail images TN11 and TN12 corresponding to two large values are displayed without reduction in the horizontal direction. The size of the thumbnail image TN1 corresponds to the viewership r1. The size of the thumbnail image TN12 corresponds to the viewership r2. In FIG. 28, the viewership r2 is higher than the viewership r1. Therefore, the thumbnail image TN12 is displayed larger than the thumbnail image TN11.

There are various methods of determining, in the sequence of images, the thumbnail image of which scene is to be displayed in an unreduced format in the horizontal direction, that is, the viewership data r is to be equal to or higher than a predetermined threshold, a high order predetermined number of scenes having high viewership is determined, etc.

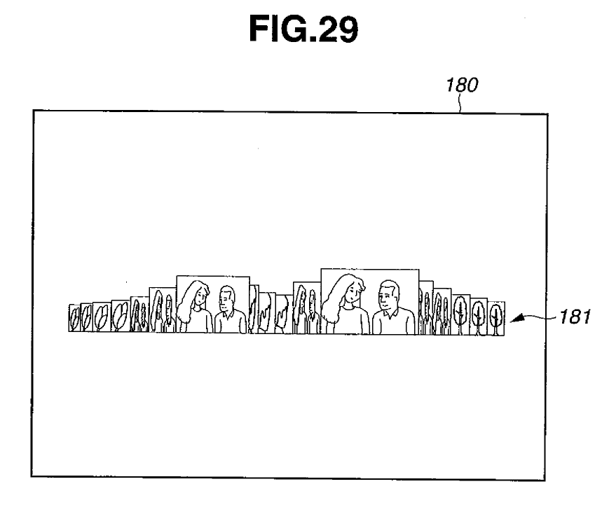

FIG. 29 shows a variation example of the display example shown in FIG. 28. FIG. 29 shows an example of displaying an image sequence 181 with the bottom sides of the thumbnail images of different sizes placed in order.

At this time, the additional information is, for example, the information based on the time series data in the text format or numeric value format as shown in FIG. 8.

For example, according to the information (time series data) below, the magnification or reduction rate of thumbnail images is changed.

1) level of excitement from acclamation
2) level of BGM and effective sound
3) level of laughter and applaud
4) density of conversation
5) viewership
6) number of recorded user members
7) number of links if there are links in the scene in animation
8) frequency of viewing of scene
9) determination value of specific detected character (probability of appearance of specific character)
10) size of detected face
11) number of detected persons
12) hit rate of keyword retrieval
13) determination value of scene change
14) highlight portion in music program
15) important portrait portion in educational program

In the information above, the magnification of thumbnail images is high.

For example, in the contents of a sports match, the excitement level of the match can be digitized by analyzing the volume of the acclaim in the contents in the voice sound processing. Depending on the excitement level, the thumbnail image is displayed large. That is, the higher the excitement level, the larger thumbnail image while the lower the excitement level, the smaller thumbnail image. In this display method, the user can immediately recognize the contents, thereby easily selecting desired scenes.

The method of representing the additional information in the contents includes, in addition to representing the reduction rate or magnification rate of a thumbnail image in the sequence of images, controlling the brightness of a thumbnail image, the thickness of the frame of a thumbnail image, the color or brightness of the frame of a thumbnail image, shifting up and down a thumbnail image, etc.

Conventionally, an excitement scene has not been able to be recognized without a troublesome process of specifying high level of, for example, voice data from the waveform of audio data, and then retrieving an image corresponding to the waveform position. However, according to FIGS. 28 and 29, the user can immediately know the excitement scene.

Furthermore, the displays as shown in FIG. 28 or 29 may be applied when the sequence of images of the contents is displayed.

There may be provided plural modes such as a mode in which an excitement scene is enlarged, a mode in which a serious scene is enlarged, etc., such that the modes can be switched to display the representation shown in FIGS. 28 and 29 depending on each mode.

### 6. Software Processing of Display Generation Unit

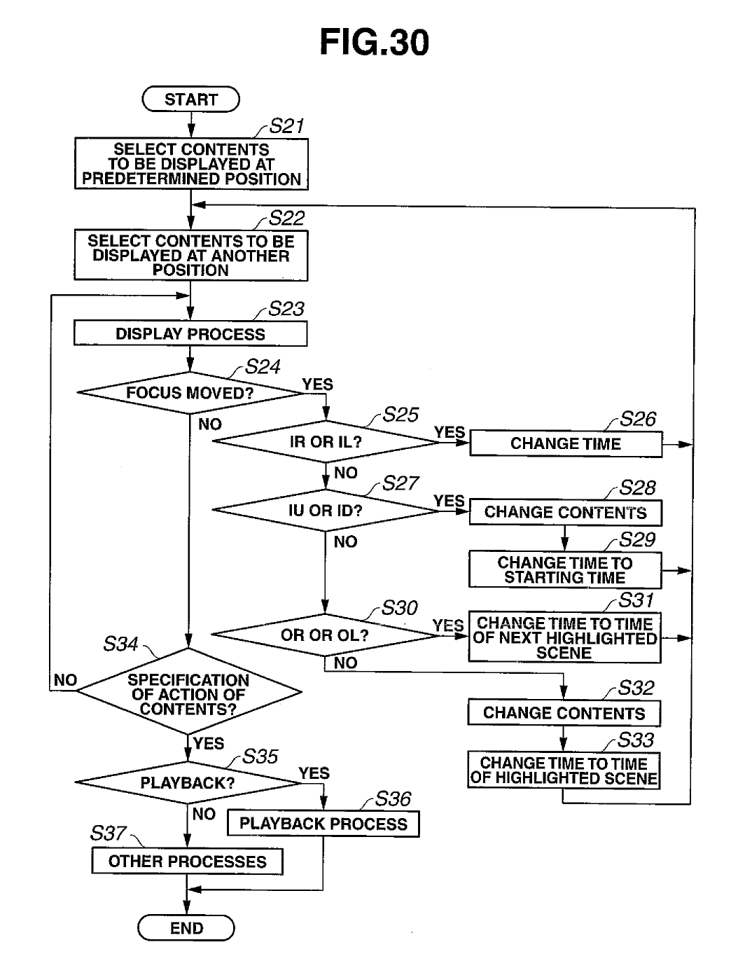

Described next is the display processing of the sequence of images of the contents displayed by the output device 13. FIG. 30 is a flowchart showing an example of the flow of the process of the display generation unit 11 to display the sequence of plural still images about plural contents. The process is described below with reference to FIG. 20.

When a user presses the GUI2 button 95e of the remote controller 12A, the process shown in FIG. 30 is performed. The process shown in FIG. 30 is performed by the display generation unit 11 by pressing the GUI2 button 95e in step S9 shown in FIG. 15. The process shown in FIG. 30 can be performed by the user selecting a predetermined function displayed on the screen of the output device 13.

First, the display generation unit 11 selects a content displayed at a predetermined position, for example, at the central position shown in FIG. 18 (step S21). The selection can be made by determining whether or not the content is the content 112d selected with reference to FIG. 17.

Next, the display generation unit 11 selects contents to be displayed in other positions than the predetermined position, for example, above or below in FIG. 18 (step S22). The contents to be displayed in other positions are selected according to a command corresponding to the selection portion selected and set in the submenu window 102 shown in FIG. 17.

The content to be displayed at the central row shown in FIG. 18 is the content 112d shown in FIG. 17, and the contents to be displayed above and below the row are the contents corresponding to plural selection portions in the submenu window 102 shown in FIG. 17. As described above, the contents to be displayed above and below are retrieved and selected as the programs in the same series based on whether or not the titles of the text in the contents information match.

The display generation unit 11 performs the display processing for displaying sequence of images based on the information about a predetermined display system and the parameter for display (step S23). As a result of the display processing, a thumbnail image generated from each framed image in the sequence of images of each content is arranged in a predetermined direction in a predetermined format. The display system refers to a display mode of the entire screen as to whether or not contents are to be displayed in a plural row format as shown in FIG. 18, whether or not contents are to be displayed in a plural row format with the position of each target image arranged in order in a predetermined direction as shown in FIG. 23, or whether contents are to be displayed in the format shown in FIG. 26 or 29. The information about the display system is preset and stored in the display generation unit 11 or a storage device. The parameter indicates the number of plural rows (for example, five rows in FIG. 18), the number of surfaces of a polygon (for example, four surfaces in FIG. 25), etc., and as with the information about the display system, is preset and stored in the display generation unit 11 or the storage device.

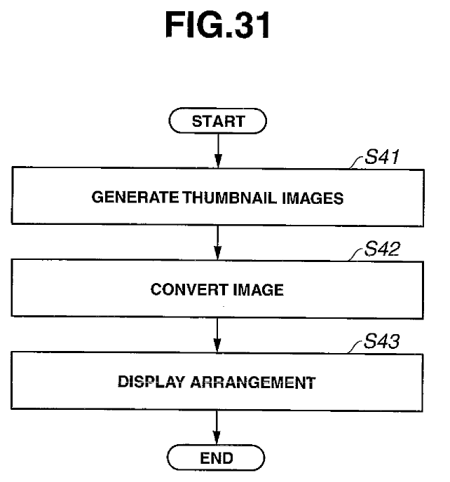

The display processing in step S23 is described below with reference to FIG. 31, FIG. 31 is a flowchart showing the flow of the process for display of the sequence of thumbnail images.

First, the display generation unit 11 generates a predetermined number of static images, that is, thumbnail images, along the lapse of time of the contents forming a sequence of images from the storage device 10A (step S41). The step S41 corresponds to a static image generation unit.

Next, the display generation unit 11 converts thumbnail images other than at least one predetermined and specified thumbnail image (a target image in the example above) from among a predetermined number of generated thumbnail images into reduced images in a predetermined format (step S42). The step S42 corresponds to an image conversion unit.

Then, the display generation unit 11 displays the at least one thumbnail image and the other converted thumbnail images as a sequence of thumbnail images arranged along a predetermined path on the screen (horizontally in the example above) and along the lapse of time (step S43). The step S43 corresponds to a display unit.

In step S23 in which the process shown in FIG. 31 is performed, the screen as shown in FIG. 18 is displayed on the display screen of the display device of the output device 13. Then, as shown in FIG. 20, if a predetermined scene is selected, for example, in a sequence of images of each content including as plural target images, a screen including images in which a goal scene as a highlight scene is selected is displayed.

Then, the display generation unit 11 determines whether or not a user has issued a focus move instruction (step S24). The presence/absence of a focus move instruction is determined depending on whether or not the cross key 95 of the remote controller 12A has been operated. If the cross key 95 has been operated, control is passed to step S25.

As described above with reference to FIG. 22, if the right cursor portion IR or the left cursor portion IL is pressed, the display generation unit 11 changes the time of the thumbnail image to be displayed as a focus image on which the cursor is placed in step S25. The focus image is displayed corresponding to the time of the thumbnail image. When the right cursor portion IR is pressed, the focus image is selected in the forward direction of the time of contents. If the left cursor portion IL is pressed, a thumbnail image is selected as a focus image in the backward direction of the time of contents. As a result, if the right cursor portion IR or the left cursor portion IL is pressed once, a thumbnail image forward or backward by a predetermined time is displayed as a focus image. After step S26, control is returned to step S22.

If the up or down cursor portion IU or ID, not the right cursor portion ID or the left cursor portion IL, is pressed, it is determined No in step S25, and it is determined YES in step S27, and the display generation unit 11 changes the content. If the up cursor portion IU is pressed, the display generation unit 11 selects the content in the upper row displayed on the screen. If the down cursor portion ID is pressed, the display generation unit 11 selects the content in the lower row displayed on the screen. Since the content is changed, the display generation unit 11 changes the time of the focus image into the starting time of the content after the change (step S29).

As a result, if the up cursor portion IU is pressed, then the frame F2 indicating a focus image moves to the content 121b, the frame F2 indicating a focus image is added to the content, and the thumbnail image as the leftmost framed image shown in FIG. 18 is displayed unreduced. If the down cursor portion ID is pressed, then the frame F2 moves to the content 121d as shown in FIG. 18, the bold frame F2 indicating a focus image is added, and the leftmost thumbnail image as a framed image is displayed as unreduced. After step S29, control is returned to step S22.

In the example above, when the content is changed, the time of the focus image becomes the starting time of the content after the change. However, the time of a focus image may be changed such that the time can be set not as a starting time, but for the same position of the focus image before the change as in the vertical direction on the screen, or for the position of the same elapsed time from the starting time of the content.

If the right cursor portion OR or the left cursor portion OL of the outside ring key 95b, not the right cursor portion IR or the left cursor portion IL, nor the up or down cursor portion IU or ID, is pressed, then the determination in steps S25 and S27 is NO, the determination is YES in step S30, and the display generation unit 11 changes the time for display of a focus image into the highlight time for the next (that is adjacent) target image (step S31). In FIG. 20, a goal scene as highlight scene is selected as a target image, but the focus image is changed to the selected highlight scene. If the right cursor portion OR is pressed, the time of the highlight scene on the right is the time of the focus image. If there is no highlight scene to the right at this time, the time of the focus image is not changed, or the time of the focus image is changed to the time of the leftmost highlight scene of the content. If the left cursor portion OL is pressed, then the time of the left and adjacent highlight scene is the time of the focus image. If there is no highlight scene to the left, then the time of the focus image is not changed, or the time of the focus image is changed to the time of the rightmost highlight scene of the content. After step S31, control is returned to step S22. In the process in step S31, the display shown in the display state SS3 shown in FIG. 22 is realized.

Thus, the focus image is transferred between the target images in the content, that is, between the highlight scenes in this example.

If the up cursor portion OU or the down cursor portion OD of the outside ring key 95b, not the right cursor portion IR or the left cursor portion IL, nor the up cursor portion IU or the down cursor portion ID, is pressed, then it is determined NO in steps S25, S27, and S30, and the display generation unit 11 changes the content (step S32). If the up cursor portion OU is pressed, the display generation unit 11 can select the content in the upper row displayed on the screen (step S32). When the down cursor portion OD is pressed, the display generation unit 11 selects the content in the lower row displayed on the screen. In addition, since the content is changed, the time of the focus image is changed to the time of the highlight scene in the content after the change (step S33).

As a result, when the up cursor portion OU is pressed, the frame F2 indicating the focus moves to the content 121b in FIG. 20, and the frame F2 indicating the focus is added to the thumbnail image of the highlight scene of the content after the change. If the down cursor portion OD is pressed, the frame F2 indicating the focus moves to the content 121d in FIG. 20, and the frame F2 indicating the focus is added to the thumbnail image of the highlight scene of the content after the change. After step S33, control is returned to step S22. In the processes in steps S32 and S33, the display in the display state SS2 shown in FIG. 22 is realized.

Thus, a focus image moves to the highlight scene of another content.

If it is determined NO in step S24, that is, if a user instruction is not a focus move instruction, the display generation unit 11 determines whether or not it is a specification of action on a content (step S34). The specification of action on a content is a content playback instruction, a fast forward instruction, an erase instruction, etc. If it is determined YES in step S34, it is determined whether or not the instruction is a content playback instruction (step S35). If the instruction is a content playback instruction, the display generation unit 11 plays back the content pointed to by the cursor from the time position of the focus image (step S36). If the instruction is other than a content playback instruction, then the display generation unit 11 performs other processes corresponding to the contents of the instructions other than the play back instruction (step S37).

As described above, in the process shown in FIG. 30, the user can display plural contents, and select desired contents and desired focus images. Furthermore, focus images can be moved more easily by the cross key 95, and can be moved even between contents, in a content, and between highlight scenes. Thus, the user can easily retrieve a scene. Since a selected scene can also be played back, the use can also easily confirm a retrieved scene.

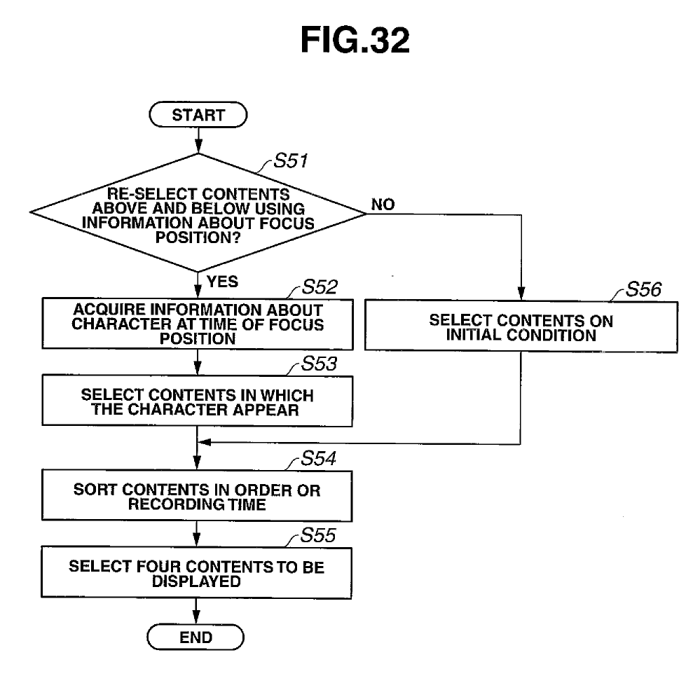

Next, using the information about the framed image at the position of the focus image, the processing as the related contents are selected is described below. FIG. 32 is a flowchart of an example of the flow of the related contents selection processing of the display generation unit 11. Described below is an example of displaying as a related content a content in which a character appearing in the focus image appears.

First, the display generation unit 11 determines whether or not the information about a framed image at the position corresponding to the focus image is to be used in selecting related contents (step S51). Whether or not the information about the framed image in the position (focus position) of the focus is to be used in selecting related contents is predetermined and stored in the display generation unit 11 or the storage device, and the display generation unit 11 can make determination based on the set information.

If it is determined YES in step S51, the display generation unit 11 acquires the information about a character at the time of the focus position (step S52). The information is acquired by, for example, retrieving the information about the character in the text data shown in FIG. 4.

Then, the content in which the character appears is selected (step S53). Practically, the display generation unit 11 searches the column of the characters in the text data, and the content storing the character name in the column is retrieved and selected.

Then, the display generation unit 11 performs rearrangement processing by sorting plural selected contents in a predetermined order, for example, recording time order (step S54). From among rearranged contents, a predetermined number of contents to be displayed, that is, four contents above and below in this example, are selected (step S55). As a result, the four selected related contents are displayed above and below the selected content as a focus image on the screen.

If it is determined NO in step 51, the related content is selected on the initial condition (step S56), and control is passed to step S54.

Since the processes above are executed each time a focus image is changed, the related contents above and below are dynamically reselected, changed, and displayed.

If the selection portion for “searching for a similar scene” has been selected (diagonal lines are added) as shown in FIG. 19, the screen as shown in FIG. 20 is displayed.

Next, the highlight display processing as shown in FIG. 28 or 29 is described below.

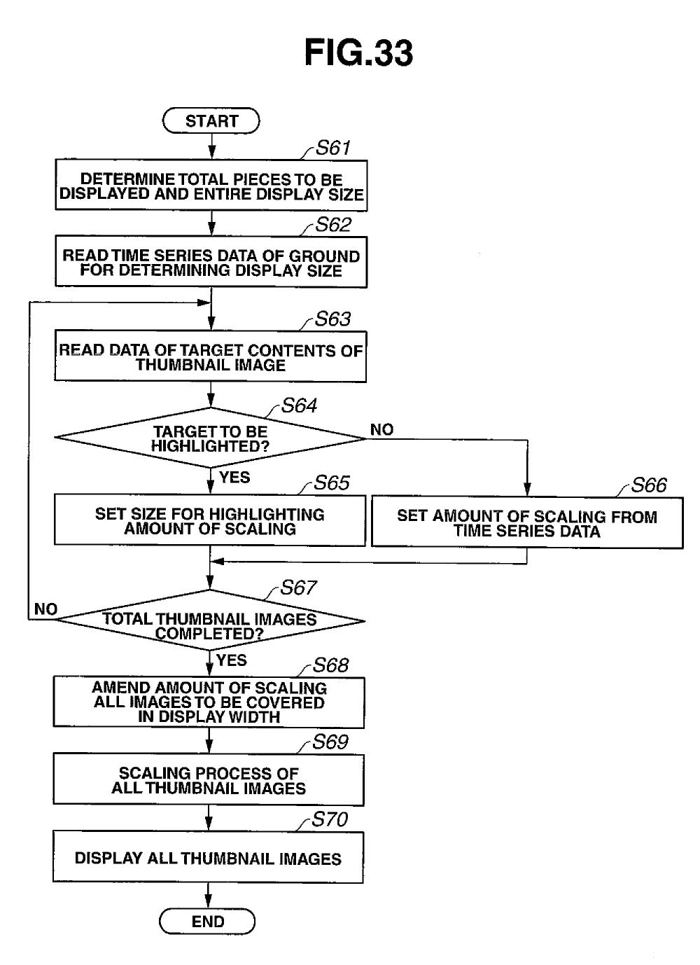

FIG. 33 is a flowchart of an example of the flow of the highlight display processing.

First, the display generation unit 11 determines the total number of thumbnail images for display of the sequence of images of contents, and the size of displayed sequence of images (step S61). Then, the display generation unit 11 acquires the time series data based on which the display size of each thumbnail image is determined (step S62). The time series data is the data in the contents information set and stored in the display generation unit 11 or the storage device.

The display generation unit 11 reads and acquires a piece of data of the thumbnail images of the target contents of the thumbnail images (step S63).

It is determined whether or not the acquired data of the thumbnail images of the target contents is the data to be displayed as highlighted (step S64).

If the data of the thumbnail images is the data to be displayed as highlighted, the amount of scaling is set for the highlight size (step S65). If the data is not to be displayed as highlighted (if NO in step S64), then the amount of scaling of the thumbnail image is determined based on the time series data (step S66).

Next, it is determined whether or not the process of the entire thumbnail image has been completed (step S67). If the process of the entire thumbnail image has not been completed, it is determined NO in step S67, and control is passed to step S63.

If the process is completed on the entire thumbnail images, it is determined YES in step S67, and when the entire thumbnail images are displayed, the amount of scaling of all images is amended so that the images can be stored in a predetermined display width (step S68). Thus, each thumbnail image can be stored in the predetermined display width.

Then, the scaling processing of the entire thumbnail images is performed (step S69). In addition, the size of the display as a sequence of images is adjusted.

Then, the display generation unit 11 displays the entire thumbnail images (step S70).

In the above-mentioned process, the sequence of images of one content is displayed highlighted as shown in FIG. 28 or 29. However, when plural sequence of images as shown in FIGS. 18, 25, etc. are displayed on the screen, the process shown in FIG. 33 is executed on each content, and all contents are displayed by performing the adjustment processing on the entire display size.

In the above-mentioned example, each thumbnail image is read one by one to be processed in step S63, but the entire thumbnail images may be read and a predetermined number of time series data, for example, higher order 10 scenes may be highlighted and displayed.

### 7. Conclusion

As described above, using the GUI1 and GUI2, the user can retrieve interesting contents in less steps in a natural association method for a person. Practically, the following processes can be performed.

(1) A video contents is searched for in a three-dimensional space of time axis by the GUI1.
(2) By considering a time axis, contents are rearranged by the GUI1 in a three-dimensional space including the time axis.
(3) The GUI1 calls a title of an interesting content.
(4) A scene is selected while browsing the entire contents by the GUI2.
(5) After browsing the scenes by the GUI2, the content in which the same character appears in the preceding day is retrieved.

As described above, the video contents display apparatus 1 of the present embodiment described above can provide a graphic user interface capable of easily and pleasantly selecting and viewing a desired video content and a desired scene in the video contents from among plural video contents.

### 8. Variation Example

Described next are variation examples of the GUI1.

There are following cases in generating a screen of the GUI1 shown in FIG. 9.

### Case 1-1)

“A user requests to view the content B produced in the same period as the content A viewed in those days or at that time.”

### Case 1-2)

“A user requests to view other video contents D or scenes E having the same period background as the scene C.”

In the case of Case 1-1, the data such as date and time of production etc. is stored as common time axis data in the contents information about the content A and content B. Therefore, by searching the data of date and time of production etc., the contents “produced in the same period” can be extracted, and the extracted contents can be displayed as a list.

In the case in Case 1-2, the data such as period settings etc. is stored as common time axis data in the contents information about the scene C, content D, and scene E. Therefore, by searching the data of period settings etc., the contents “having the same period background” can be extracted, and the extracted contents can be displayed as a list.

Therefore, in this case, if various data such as the date and time of production, the date and time of broadcast, the date and time of shooting, the date and time of recording, date and time of viewing, etc. are set as the time axis data, then, by the user using the data of the GUI1 to select the selection portion shown in FIG. 17, the screen as shown in FIG. 18 can be displayed, and a retrieval result can be displayed as a list.

That is, when a user as a person memorizes an event etc. along a time axis, the device according to the present embodiment provides a screen display shown in FIG. 9, and retrieves a content corresponding to the time axis. At this time, using the selection portion as shown in FIG. 17, the user can easily retrieve a content with the time axis of the date and time of production, the date and time of broadcast, etc. as a key.

However, there are also the following cases.

### Case 2-1)

“The user requests to view the content Q frequently viewed when the content P is purchased and the content R having the same period settings.”

### Case 2-2)

“The user requests to view the content B broadcast when the content A is previously viewed.”

In Case 2-1, the time when the content P is purchased (date and time) matches the time when the content Q is viewed (date and time), but the time axes of the two times (date and time) are different from each other. One is the date and time of purchase, and the other is the date and time of viewing. Therefore, in the user view space 101 as shown in FIG. 9, the two contents are not always arranged close to each other. Since the contents Q and R have the same date and time of period setting on the common time axis, they are displayed close to each other in a three-dimensional space.

In Case 2-2, the time when the content A is viewed previously (or last time)(date and time) is close to the time when the content B is broadcast (date and time), but the time axes of the times (date and time) are different from each other. One is the last date and time of viewing, and the other is the date and time of broadcast. Therefore, in the user view space 101 of the GUI1 described above, the contents A and B are not necessarily arranged close to each other.

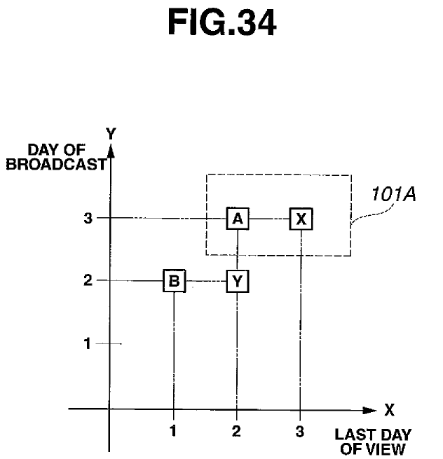

These cases are described below with reference to the attached drawings. FIG. 34 is an explanatory view of the Case 2-2.

In FIG. 34, the horizontal axis indicates the time axis of the last playback, that is, the last viewing (last date and time of viewing), and the vertical axis indicates the time of broadcast, that is, the time axis of the date and time of broadcast. In FIG. 34, plural blocks shown by squares indicate the respective contents. The content A was broadcast three years ago, and last viewed two years ago. The content B was broadcast two years ago, and finally viewed one year ago. The content X has the same date and time of broadcast as the content A, and the last date and time of viewing is three years ago. The content Y has the same date and time of broadcast as the content B, and has the same last date and time of viewing as the content A. In the Case 2-2, retrieving the content X having the same date and time of broadcast as the content A only requires retrieving the data on the same time axis. Therefore, it is as easy as the above-mentioned cases 1-1 and 1-2. In this case, as a result of the retrieval, the content X is displayed close to the content A in the user view space 101 (the range 101A indicated by the dotted line shown in FIG. 34) of the GUI1. Also retrieving the content Y having the same date and time of viewing as the last date and time of viewing of the content A only requires retrieving the data on the same time axis, and can be easily performed similarly.

However, in Case 2-2 of “content B broadcast when the content A is previously viewed”, the content B cannot be retrieved from the contents information about the content A.

Four methods of solving the above-mentioned problems are described below.

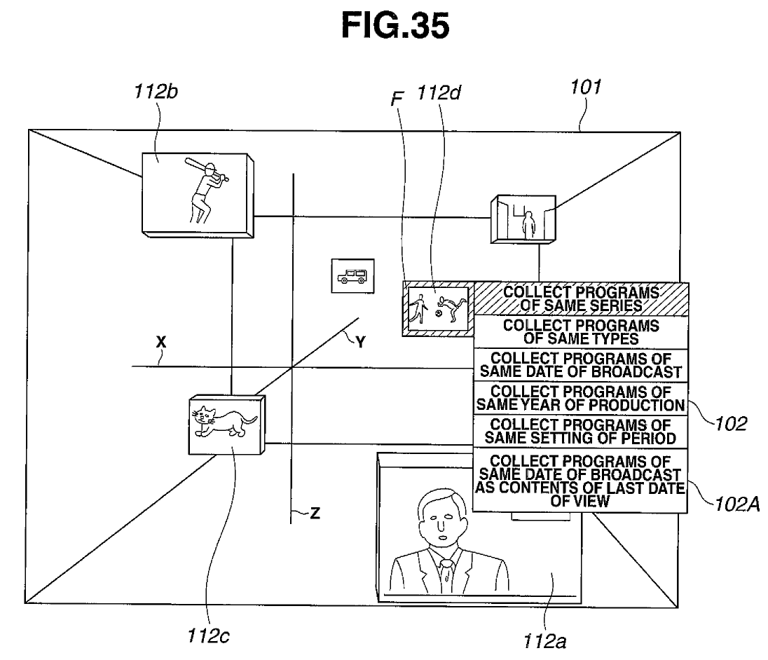

First, the first solution is described. FIG. 35 is an explanatory view of the screen relating to the first solution.

FIG. 35 shows a screen similar to FIG. 17. The selection portion for issuing a command to “collect the content having the same broadcast as the last date of viewing of the content” is added to the popup display of the submenu window 102. Therefore, the user selects the selection portion 102A in the case as the Case 2-2 so that a desired content can be retrieved in Case 2-2.

Additionally, in Case 2-1, although not shown in the attached drawings, the selection portion to “collect a content having the same period settings as the content broadcast on the purchase day of the content” is added. In addition, for example, a selection portion can change the view point position by “moving to the view point centering the date and time of the time axis B (axis of the date and time of broadcast day) having the same date and time of the time axis A (axis of the date and time of previous viewing)”, “moving to the view point centering the date and time of the time axis C having the same date and time of the time axis A (axis of the date and time of previous viewing)”, etc.

As described above, using the command by the selection portion, and using the time axis data with the contents information about a content in the focus state, data of another time axis is retrieved so that related contents can be retrieved in Cases 2-1 and 2-2.

As described above, plural selection portions corresponding to the combination of estimated retrieval may be prepared, such that the plural selection portions can be displayed on the screen as a selection menu, but a screen on which related combinations can be selected may be displayed, such that the combination is selected to allow generating the retrieval command.

Next, the second solution is described below.

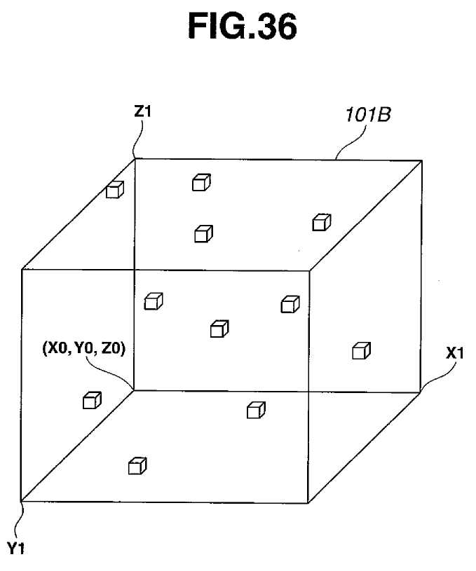

FIG. 36 is an explanatory view of the second solution.

In the above-mentioned Case 2-2, relating to the content in the focus state, there are the data of the last date and time of viewing, that is, “two years ago” in this embodiment and the data of the date and time of broadcast, that is, “three years ago” in this embodiment. The second solution uses the time axis data of “two years” and “three years” to expand and display, the display range of the user view space. That is, the second solution is to determine the display range of the user view space, and expand and display it only using the time data (in the example above, the time data of “two years” regardless of the time axis of “date and time of viewing”, the time data of “three years” regardless of the time axis of “date and time of broadcast”) regardless of the time axis of the time data relating to the retrieval condition of Case 2-2 etc. in a time range in which there can be a content to be retrieved and viewed.

From the time data of “two years” and “three years”, the display range of the user view space 101 is set to one year from two years ago to three years ago in each time axis to generate, the data of a user view space and display the user view space. As a result, in the user view space 101, only the content in the display range is displayed, and the user can easily find a target content. In FIG. 36, the user view space 101B is a space having the time width (X0, X1), (Y0, Y1), (Z0, Z1) of two years ago to three years ago on each time axis. The point (X0, Y0, Z0) corresponds to the date and time of two years ago in the three time axes of X, Y, and Z, X1 corresponds to the date and time of three years ago, Y1 corresponds to the date and time of three years ago on the Y axis, and Z1 corresponds to the date and time of three years ago on the Z axis. The user view space 101B is displayed on the screen in the format shown in FIG. 9 etc. In the user view space 101B, there is only the content in a time width of one year at the time axis, the user can easily select a desired content.

When there are three or more pieces of time data, the maximum and minimum values of the three pieces of data have only to be used as the display range data for all three time axes of the user view space 101B.

If there are still a large number of contents although the display range is limited, the types of contents may be limited from the user taste data, that is, the user taste profile, thereby decreasing the number of contents to be displayed.

Otherwise, an upper limit may be placed on the number of contents to be displayed, such that if the upper limit is exceeded, the contents with the upper limit are extracted by random sampling, thereby limiting the number of contents to be displayed.

As described above, the time data relating to the retrieval condition is extracted regardless of the time axis, and the time data is used as data in determining the display range of the user view space. Thus, the display range can be limited to the time range in which there can be a content to be retrieved and viewed, and the user can retrieve related contents in Cases 2-1 and 2-2.

Described below is the third solution.

In Cases 2-2 above, the content in the focus state has three time data about three time axes. Then, a content having the time data the same as or similar to each piece of the three time data with respect to another time axis is retrieved and extracted, and the retrieved content is displayed in the user view space as the third solution. That is, according to the third solution, displayed are contents having time data of three time axes the same as or similar to each time data of the three time axes of the content in other two time axes than the time axis to which the time data belongs.

Practically, if there are time axes of the date and time of production, the date and time of broadcast, and the final date and time of playback as the three time axes of a content in the focus state, a time axis other than the three time axes is retrieved using the three pieces of data. That is, contents having time data the same as or similar to the time data relating to the X axis and also having the time data relating to the Y and Z axes are retrieved. Similarly, contents having time data the same as or similar to the time data relating to the Y axis and also having the time data relating to the X and Z axes are retrieved. Similarly, the contents having the time data the same as or similar to the time data relating to the Z axis and also having the time data relating to the X and Y axes are retrieved, and they are displayed with the contents in the focus state in the user view space. As a result, the contents having the time data the same as or similar to the three pieces of data can be retrieved. Then, the extracted and acquired contents are displayed in the screen format as shown in FIG. 9.

Thus, the user can easily retrieve the contents relating to the contents in the focus state.

Described below is the fourth solution.

The fourth solution is to include the date and time of occurrence of an event in an absolute time for each content in the contents information (or related to the contents information), and display on the screen such that the concurrence and the relation of the date and time of occurrence of an event between the contents can be clearly expressed. That is, the fourth solution stores one or more event occurring in a content as associated with the time information (event time information) in the reference time (in the following example, the absolute time of the global standard time etc.) indicating the time of the occurrence, and displays the event on the screen such that the concurrence etc. of the date and time of occurrence of the event between the contents can be clearly expressed.

Described practically below is the fourth solution.

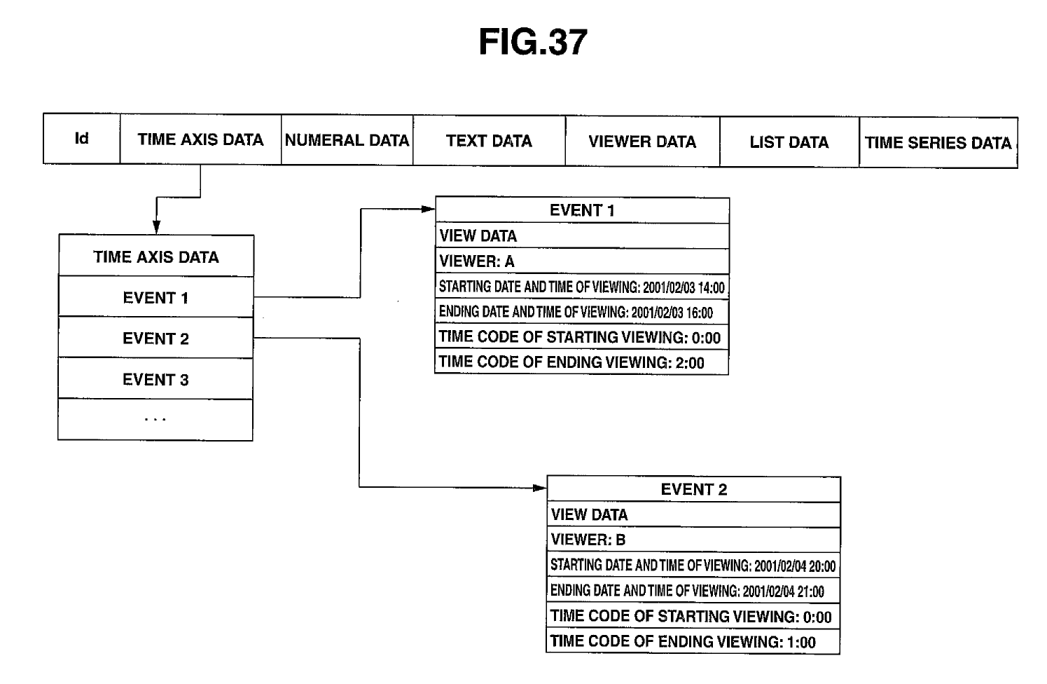

First, the contents information relating to the fourth solution is described below. FIG. 37 is an explanatory view of the data structure of the time axis data in the contents information. The time axis data is, as shown in FIG. 37, includes plural pieces of event information for each content. The time axis data in the contents information has plural event information as separate table data by a pointer. Each piece of event information is further hierarchically configured, and includes “type of event”, “starting time of event”, “ending time of event”, “target content starting time (time code of content)”, and “ending time of target content (time code of content)”. Each event information includes, in an example shown in FIG. 37, for an event of viewing a viewer, a date and time of starting viewing, a date and time of ending viewing, a time code of starting viewing, and a time code of ending viewing as time data. In each piece of event information, the time code of starting viewing and the time code of ending viewing indicate time data indicating relative time, and the date and time of starting viewing and the date and time of ending viewing are data indicating the absolute time. For example, in the event 1, the time data of the date and time of starting viewing is “2001/02/03 14:00” indicating “Feb. 3, 2001 at 14:00”, and the time data of the date and time of ending viewing is “2001/02/03 16:00”, and the absolute time data indicating Feb. 3, 2001 at 16:00, and the time code of ending viewing is “2:00”. Therefore, it indicates that the viewer viewed the 2-hour program for two hours. Therefore, the data of the absolute time other than the data indicating the relative time is used as the time data of an event.

FIG. 37 shows an example of the view information as event information, but also includes, as event information for each content, the information about the date and time of production, date and time of broadcast, etc. In the period setting etc. of the content, the period or the date and time implied by all or a part (scene, chapter, etc.) of the contents is assumed as the date and time of occurrence of the event.

That is, the target to be stored as event information is predetermined, and if the operation etc. by the user for the TV recorder etc. as a video contents display device corresponds to the predetermined event, event information is generated as associated with the content for which the event has occurred based on the operation, and the information is added to the contents information about the storage device 10A.

As described above, for some contents or time axes, it may be not necessary to store the time data in hour, minute, and second for the date and time data in the event information. In this case, only the year, or only the year and month may be stored as period data. For example, only the year for time data or the period data of only the year and month are recorded for the time axis of the content or period setting of a history drama.

Furthermore, the data structure may be a table format related to a sequence of events using the content as a key, and expressed in an XML format.

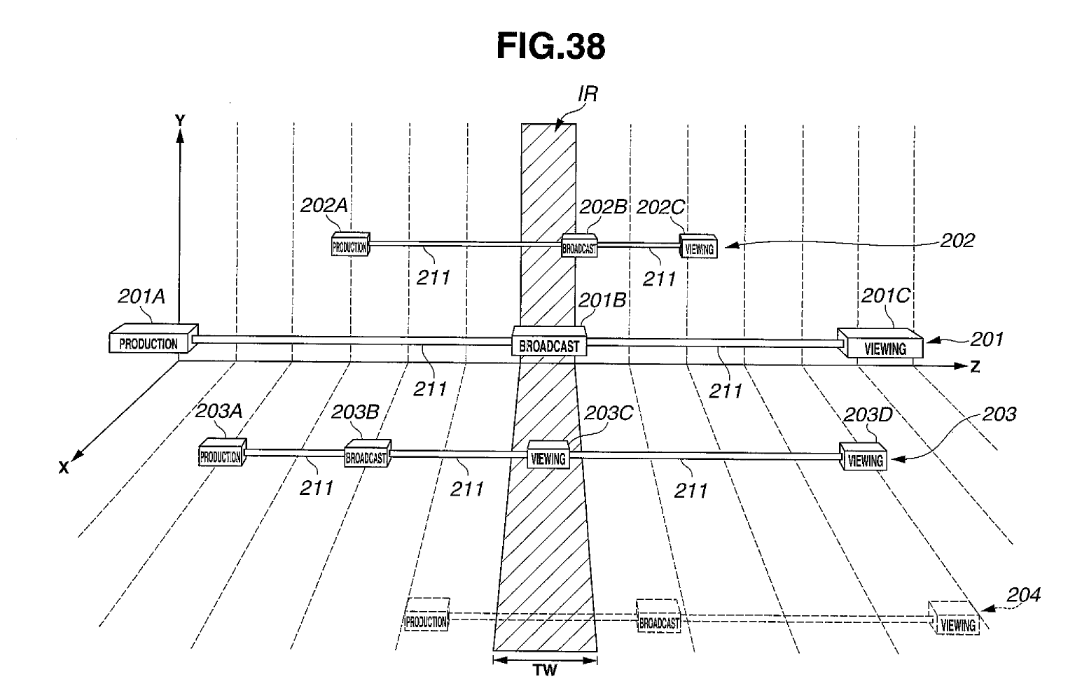

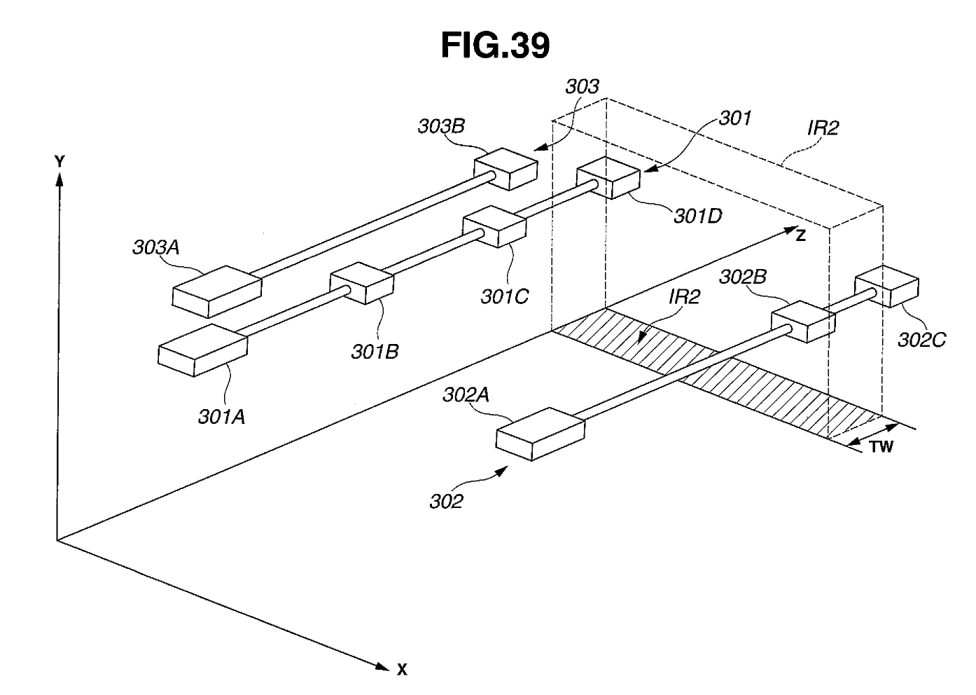

The video contents display apparatus 1 can display the three-dimensional display screen as shown in FIG. 38 or 39 on the display screen of the output device 13 according to the event information. The image shown in FIG. 38 or 39 is displayed on the display screen of the output device 13 viewed by the user as a user view space. When there is a predetermined operation on the remote controller 12A, for example, an operation of pressing a predetermined button, then the screens of FIGS. 38 and 39 are generated by the display generation unit 11. The process for displaying is described later. Described below is the case in which the user can select the screen shown in FIG. 38 or 39.

FIG. 38 is a display example of displaying in a predetermined expressing form in a three-dimensional array plural contents existing in a virtual space configured by three time axes in which one of the three time axes is fixed as the time axis of the absolute time as the time axis of a predetermined reference time, and the remaining two time axes are user specified time axis. The absolute time is a time for which the occurrence time of each event such as the birth, contents, viewing, etc. of a content can be uniquely designated as described above, and is, for example, a reference time indicating the date and time of the Christian era in the global standard time etc.

In FIG. 38, the X axis is the time axis of a date and time of broadcast or a date and time of recording, and Y axis is a time axis of a set period, and Z axis is a time axis of an absolute time. FIG. 38 shows an example of a screen display when the state of arranging plural contents in a corresponding position in timing in a three-dimensional space formed by the three time axes is viewed from a view point. In FIG. 38, the view point for a user view space is a position of viewing from a direction orthogonal to the absolute time axis (Z axis), and is predetermined. Each content is displayed such that plural blocks each indicating an event are arranged parallel to the absolute time axis.

The axes other than the Z axis may not relate to time. For example, the X axis and Y axis may indicate titles in the order of a sequence Japanese characters, in the alphabetical order, in the order of user viewing frequency, etc.

Practically, as shown in FIG. 38, in order to visually check the occurrence of an event in each content, a content 201 is displayed such that a block 201A indicating a production event, a block 201B indicating a broadcast event, and a block 201C indicating an event of viewing are arranged parallel to the time axis Z of the absolute time at a position corresponding to the date and time of occurrence of each event. Furthermore, to indicate that the three blocks relate to one content, the three blocks are displayed as connected through a bar unit 211. That is, each content is represented such that plural blocks respectively indicating an event are connected by the bar unit into one structure.

Furthermore, each content is arranged in a corresponding position on each time axis with respect to other user selected time axes (X axis and Y axis). In the case shown in FIG. 38, each content is arranged on the X axis at the position of the date and time of broadcast of each content, and on the Y axis at the position of the set period of the content.

In FIG. 38, the contents of each event are indicated at each block so that a user can easily understand the contents of the event. The contents may also be identified by a color, a symbol, etc.

Similarly, other contents 202 and 203 are displayed. Practically, the content 202 includes three events, and three blocks respectively indicating the three events are connected by the bar unit 211. The content 203 includes four events, and four blocks indicating the four events are connected by the bar unit 211.

In this example, when plural contents are displayed in a predetermined display mode, an event is represented in a block form, and the connection between the blocks is indicated by a bar unit. The predetermined display mode may be any other display modes than the display mode shown in FIG. 38.

In the display state shown in FIG. 9, when a user performs a predetermined operation, for example, an operation of pressing a predetermined button of the remote controller 12A with the contents to be focused selected using a pointing device such as a mouse etc., the screen shown in FIG. 38 is displayed on the display screen of the output device 13.

In FIG. 38, a predetermined event (in this example, the event at the center on the absolute time axis in plural events) in the content in the focus state is centered on the screen, and other contents including an event having the same or close date and time of occurrence of the event are displayed.

Practically, a content 201 has three events 201A, 201B, and 201C, In FIG. 38, the block 201B (event of broadcast) indicating the event at the center or substantially at the center on the absolute time axis in the three events is arranged at the center of the screen as a block of the selected event. Then, the contents 202 and 203 including the events (202B (event of broadcast), and 203C (event of viewing)) having the same or close date and time of occurrence of the event of the selected block 201B are also displayed in the state arranged in the three-dimensional space. That is, the user can be informed that the date and time of the broadcast of the reference content 201 is close to the date and time of the broadcast of the content 202 and the date and time of viewing of the content 203.

There is a portion having a predetermined width at the center of the screen. The portion indicates an attention range IR as a portion indicated by diagonal lines in FIG. 38. The attention range IR is a time range TW for retrieval as to whether or not there is an event having the same or close date and time of occurrence of the selected event in the content in the focus state on the absolute time axis. In FIG. 38, it is displayed at a predetermined position (center on the screen in this example). Therefore, based on the date and time of occurrence of the selected event, another event with the date and time of occurrence is displayed as extracted as another content including an event having the same or close date and time of occurrence of the selected event in the range of the reference time ±TW/2 (that is, from −TW/2 to +TW/2).

In FIG. 38, the dotted line drawn parallel to the belt of the attention range IR indicates the scale display unit indicating the same time width as the time width TW.

A method of specifying a selected event can be, as described above, automatically specifying the event at the center or substantially at the center of the plural events of the content as a selected event when a predetermined operation is performed for screen display shown in FIG. 38 in the state of the screen display shown in FIG. 9. As a result, the selected event is arranged in the central attention range IR, and a content including an event occurring in the attention range IR among other contents is displayed as the contents 202 and 203 as shown in FIG. 38.

In the above-mentioned example, an event at the center or substantially the center of plural events of the content in a focus state is a selected event, but other events (for example, the events as the earliest date and time of occurrence (event 201A in the content 201)) can be selected events.

Furthermore, in a state in which a once selected event is displayed as included in the attention range IR, a predetermined operation can be performed using a mouse etc., to define another event as a selected event. For example, in the display state of the display screen shown in FIG. 38, if the event 201C is selected using a mouse etc., the viewpoint position is changed to the position at which the event 201C is viewed from the direction orthogonal to the Z axis, and the event 201C is arranged at the center of the screen, and the content having the event occurring in the attention range IR based on the event 201C is displayed as shown in FIG. 38. Thus, an event to be arranged in the attention range IR can be selected by the specification by a user operation. The selection can also be performed on the event of other content not in the focus state. For example, the event 202C of the content 202 can be selected. In this case, the content in the original focus state may be changed to the content 202, or may be the content 201 as is.

Furthermore, the selection may be performed by pressing the left and right keys of the arrow keys on the keyboard etc. to move the viewpoint position by a predetermined amount or continuously while the key is pressed in the direction selected by the left and right key. At this time, the attention range IR also changes on the time axis of the absolute time with the movement of the viewpoint position. When the event of the content in the focus state is positioned in the attention range IR, it is assumed that the event is selected, and each content enters the display state as shown in FIG. 38.

In the description above, the contents 202 and 203 including an event having the same or close date and time of occurrence of the event 201B are displayed. However, a content (for example, the content 204 indicated by the dotted line in FIG. 38) not including an event having the date and time of occurrence in the attention range IR may also be displayed in a display mode different from the other contents 201, 202, and 203. The different display mode is, for example, a mode in which the brightness is generally decreased, a mode in a transmission mode, etc.

Therefore, depending on the change of the selected event, a content including an event having the same or close date and time of occurrence of the selected event, and a content including no event having a date and time of occurrence in the attention range IR are changed, and the display mode of each content dramatically changes.

As described above, according to the display screen shown in FIG. 38, a content including an event having the same absolute time of the occurrence of the selected event in the contents or an event having close time of occurrence can be easily recognized.

If a user requests to “view a content B broadcast when the content A was previously viewed” as in Case 2-2, the user can easily extract or determine by viewing the screen shown in FIG. 38 that the view event of the previous “view” of the content A is the same as or close to the date and time of occurrence of the broadcast event of “broadcast”.

Similarly, in Case 2-1 “The user requests to view the content Q frequently viewed when the content P was purchased and the content R having the same period settings”, the user can easily determine by checking the screen shown in FIG. 38 that the purchase event of “purchased” of content P is the same as or similar to the view event of “viewing” in date and time of occurrence, and furthermore, the user can easily determine the contents in the same position of period setting.

FIG. 39 as well as FIG. 38 shows a display example in a three-dimensional array in a predetermined display mode of plural contents existing in a virtual space configured by three time axes in which one time axis in the three time axes is fixed as the time axis of the absolute time and remaining two time axes are specified by the user. FIG. 39 is different from FIG. 38 in viewpoint position, and the viewpoint position can be set and changed. In the display state shown in FIG. 39, the viewpoint position can be changed by performing a predetermined operation.

FIG. 39 shows three contents 301, 302, and 303. The content 361 includes four events 301A, 301B, 301C, and 301D. The content 302 includes three events 302A, 302B, and 302C. The content 303 includes two events 303A and 303B.

FIG. 39 shows selecting the event 301D of the content 301 in the focus state, and displaying the attention range IR2 as a three-dimensional area. Therefore, by changing the position of a view point, the user can easily determine that there is the event 302B of the content 302 as an event same as or similar to the event 301D in date and time of occurrence.

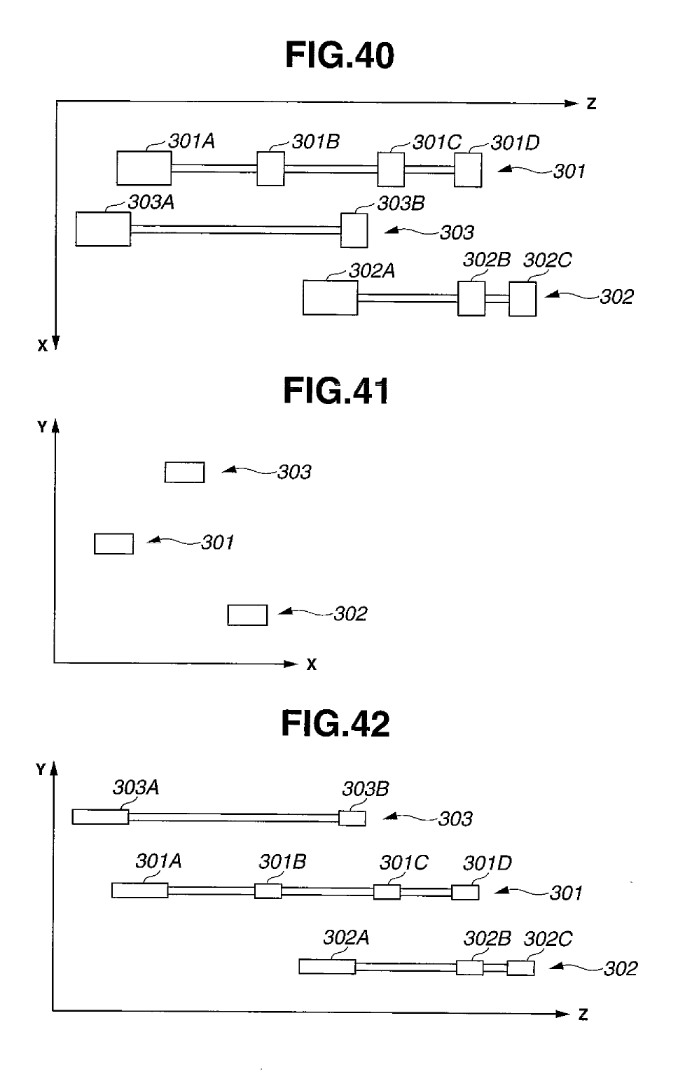

FIGS. 40 to 42 show the arrangement of each content and event in FIG. 39 as viewed from the direction orthogonal to the plane XZ, plane XY, and plane YZ, respectively.

Also in the display state shown in FIG. 39, the user can not only move a view point, but also perform the selecting operation on an event as shown in FIG. 38. That is, the user can change a selected event using a mouse etc.

In the case shown in FIG. 39, a highlight display (by changing colors etc.) may be performed on the event entering the attention range IR2.

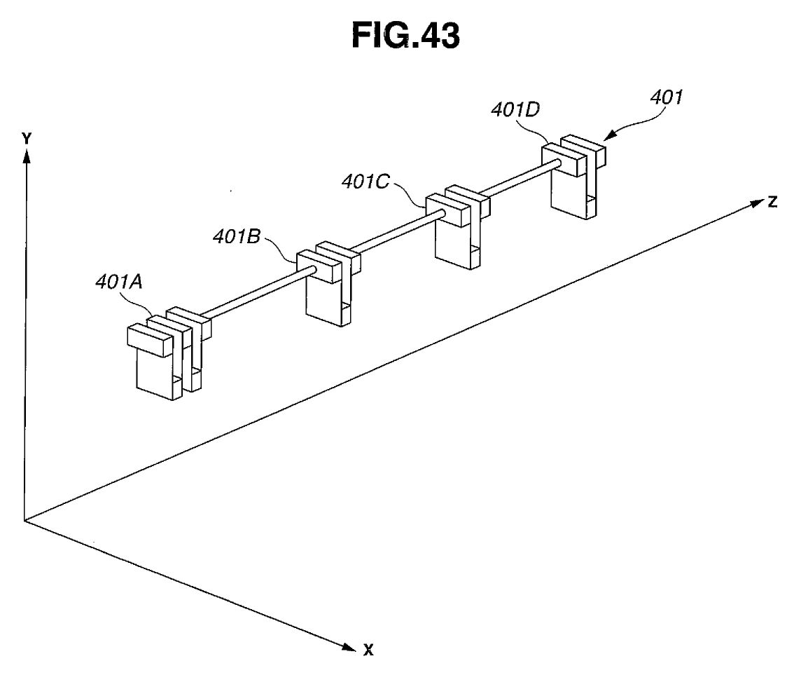

FIG. 43 is an explanatory view of another example of displaying an event. In some contents, period settings can be variable in the cut, scene, chapter, etc. FIG. 43 shows another example of displaying method of an event in this case. If period settings change in one event, the changed portion, such as or scene is separately displayed. In FIG. 43, there are four events, and each event is displayed with a part of the block shifted in a direction parallel to the time axis of the period setting.

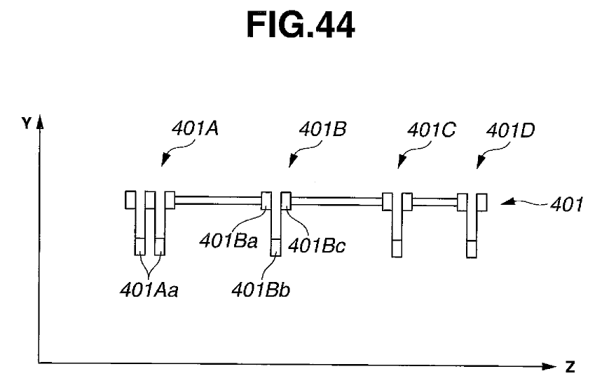

A practical example is described below with reference to FIG. 44. FIG. 44 is an explanatory view for explanation of the configuration of each block when viewed from the direction orthogonal to the YZ plane.

When a content 401 is produced, it is assumed that the past scene is located and shot in two divisions. In this case, as shown in FIG. 44, since the past scene is located and shot in two divisions in the production event 401A, a part 401Aa (point) of the block 401A is displayed as shifted along with the time axis of the set period. Also in the broadcast example 401B, the set period of a drama is changed from the state 401Ba in the year of “living peacefully in these days” to the state 401Bb in the year of “a time warp to the past”, and then changed to the state 401Bc in the year of “safely returning to the current world”. Then, as viewed from the direction orthogonal to the YZ plane, a part of blocks are displayed as shifted depending on the set period in the time axis direction of the set period.

With the display, a user can easily recognize the change although there is a change in time on the time axis in one event.

As described above, as shown in FIGS. 38 to 42, each content is linearly expressed as plural events connected to each other, but as shown in FIGS. 43 and 44, there is a case in which the contents are not linearly displayed. Therefore, each content is linearly displayed as connected like a life log, and what indicates an event is displayed on the straight line. However, the life log can be nonlinear, and data can be discontinuous. Especially, in the program such as a summary edition of old famous movies, the date and time of production is different each time a movie is cited, and the date and time of production can be discontinuous.

In FIG. 38 or 39, when the range of the user view space displayed is limited to the date and time relatively new including the current days, the time intervals on the time axis is broad, and when the date and time is limited to those relatively old to include old years and days, it is preferred that the time intervals on the time axis is displayed narrow. For example, for the event in the contents of old dramas, the time width of the attention ranges IR and IR2, the time width of the attention ranges IR, IR2 is changed to set a narrow time width of “hour, minute,” etc. can be set for the events in the contents of a drama describing events on one day.

Next, the process of the screen display shown in FIGS. 38 and 39 is described.

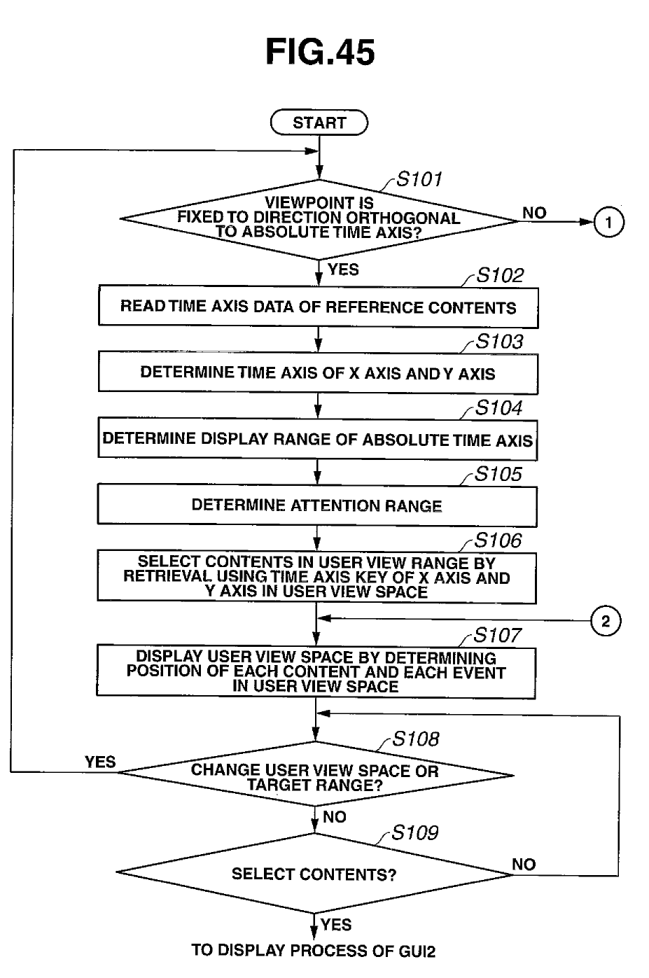

FIG. 45 is a flowchart of the example showing the flow of the process of the screen display shown in FIGS. 38 and 39. As described above, when the screen shown in FIGS. 38 and 39 is displayed, a user presses a predetermined button of the remote controller 12A, for example, the GUI3 button 95f. Then, the screen shown in FIGS. 38 and 39 is displayed on the display screen of the output device 13. Therefore, the process shown in FIG. 45 is performed when the GUI button 95f is pressed. The GUI3 button 95f is an instruction portion for outputting a command to perform a process of displaying a content as shown in FIGS. 38 and 39 cause to the display generation unit 11.

First, when the GUI3 button 95f is pressed, the display generation unit 11 determines whether or not the view point for the user view space is fixed to the direction orthogonal to the absolute time axis (step S101). The determination is performed by a user according to the information predetermined in the memory of the display generation unit 11, for example, rewritable memory. For example, if a user sets the display shown in FIG. 38 at default, the determination is YES in step S101. If the user sets the display shown in FIG. 39, the determination is NO in step S101.

The GUI3 button 95f may be designed so as to, when not preset, be pressed to display a popup window that allows the user to input and select one of the displays of FIGS. 38 and 39.

Next, the display generation unit 11 reads the time axis data of the content in the focus state, that is, the reference content (step S102). The read time axis data is a time axis data including the event information shown in FIG. 37.

Next, the display generation unit 11 determines the time axes of the X axis and the Y axis (step S103). The determination is performed by a user according to the information preset in the memory of the display generation unit 11, for example, rewritable memory. For example, if the user sets the time axes of the X axis and the Y axis shown in FIG. 38 corresponding to the respective time axes at default, then the time axes of the X axis and Y axis can be determined based on the settings.

Although settings are not preset, a predetermined popup window may be displayed on the screen to allow the user to select the time axes of the X axis and the Y axis.

Next, the display generation unit 11 determines the display range of the absolute time axis (step S104). The display range of the absolute time axis can be determined by the data indicating the range, for example, from “1990” to “1999”. The display range in the Z axis direction in the user view space shown in FIG. 38 is determined in step S104. The determination may be preset by a user to be made according to the information stored on the memory of the display generation unit 11, or a predetermined popup window may be displayed on the screen to allow a user to input the data of the display range in the Z axis direction.

Next, the display generation unit 11 determines the range of concern IR (step S105). The range of concern IR in the Z direction within the user view space in FIG. 38 is determined in step S105. This determination may also be made based on information which has been predefined by the user and stored in the memory of the display generation unit 11, or by displaying a predetermined pop-up window on the screen and allowing the user to input data on the range of concern in the Z direction.

Further, the display generation unit 11 uses time axis keys of the X and Y axes to retrieve contents in the range of the user view space in order to extract and select the contents in the user view range (step S106). The display generation unit 11 determines the position of each of contents in the user view space in FIG. 38 and the position of each event to display the user view space (step S107). The step S107 corresponds to the position determination unit that determines positions on plural time axes for each of plural video contents and a position on the absolute time axis for each of plural events, based on time information of the plural video contents and event time information. The step S107 also corresponds to the video contents display unit that displays each of the plural video contents in association with the time axes of plural specified time axes and displays each event in association with the time axis of the absolute time, which are arranged on the screen of the display device in a predetermined display format, based on position information for each of contents.

The user can manipulate the arrow key, the mouse and the like to change the display range of the range of concern in the user view space while viewing the user view space in FIG. 38.

In response to such manipulation, the user view space or the range of concern will be changed. Accordingly, the display generation unit 11 determines whether or not the user view space or the range of concern has been changed (step S108). When the display generation unit 11 determines that such a change has been made and YES in step S108, the process returns to step S101. Alternatively, when YES in step S108, the process may be returned to step S104 or other steps.

When such a change has not been made, which is indicated by NO in step S108, the display generation unit 11 determines whether or not one of contents has been selected (step S109). Once the content has been selected, the display generation unit 11 performs a process for displaying the GUI2 (such as FIG. 18). When the contents has not been selected, which is indicated by NO in step S109, the process returns to step S108.

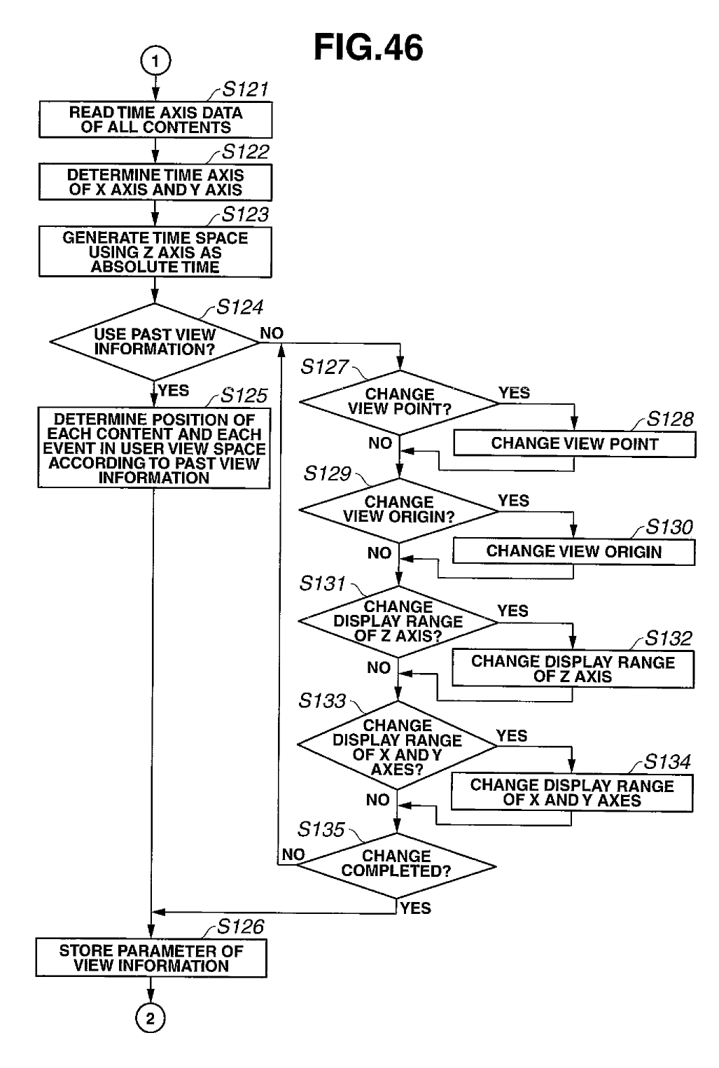

When NO in step S101, the process continues with the process in FIG. 46. The process in FIG. 46 is to display the user view space in FIG. 39.

The display generation unit 11 reads time axis data for all contents (step S121). The display generation unit 11 then determines time axes of the X and Y axes (step S122). Similarly to step S103 as described above, this determination may also be made based on information predefined by the user in the memory, e.g. a rewritable memory, of the display generation unit 11, or by displaying a predetermined pop-up window on the screen to allow the user to select respective time axes of the X and Y axes.

Next, the display generation unit 11 determines and generates X, Y and Z three dimensional time spaces, with the Z axis being as the absolute time (step S123).

The display generation unit 11 then determines whether or not past view information is used (step S124). When past view information is used, which is indicated by YES in step S124, the display generation unit 11 determines the position of each of contents in the user view space and the position of each event (step S125). The step S125 corresponds to the position determination unit that determines positions on plural time axes for each of plural video contents and a position on the absolute time axis for each of plural events, based on time information of the plural video contents and event time information.

The view origin may be defaulted to center the current date. In addition, some scales of each axis may be selectable, for example, in hour, week, month or other unit.

The display generation unit 11 then saves each parameter of the view information in the storage device 10A (step S126).

When NO in step S124, or past view information is not used, the display generation unit 11 performs a process to change the view information. In the process to change the view information, a pop-up window that has plural input fields for inputting each of parameters of the view information can be displayed to allow the user to input each parameter and finally operate a confirmation button and the like to accomplish the setting. Alternatively, plural parameters may be separately set by the user.

Therefore, a determination is initially made whether or not the viewpoint is changed (step S127). When the viewpoint is to be changed, which is indicated by YES in step S127, the display generation unit 11 performs a process to change the parameters for the viewpoint (step S128).

After steps S127 and S128, a determination is made whether or not the view origin is changed (step S129). When the view origin is to be changed, which is indicated by YES in step S128, the display generation unit 11 performs a process to change the parameters for the view origin (step S130).

Similarly, after steps S129 and S130, a determination is made whether or not the display range of Z axis is changed (step S131). When the display range of Z axis is to be changed, which is indicated by YES in step S131, the display generation unit 11 performs a process to change the parameters for the display range of Z axis (step S132).

Similarly, after steps S131 and S132, a determination is made whether or not the display range of X or Y axis is changed (step S133). When the display range of X or Y axis is to be changed, which is indicated by YES in step S133, the display generation unit 11 performs a process to change the parameters for the display range of X or Y axis (step S134).

Incidentally, the change of the display range in steps 132 and 134 may be performed using either data for a specific time segment, for example, years from “1990” to “1995”, or ratio or scale data.

After steps S133 and S134, a determination is made whether or not the change process for the view information is completed (step S135). The determination can be made based on, for example, whether or not a confirmation button is pressed as described above. When NO in step S135, the process returns to step S127. When YES in step 135, the process continues with step S126.

When the view information is changed from steps S127 to S135, it is possible to make a display viewed in the direction perpendicular to the XZ, XY, or YZ plane as shown in FIGS. 40, 41 and 42, instead of the view space viewed at an angle as shown in FIG. 39.

After the step S126 process, the process continues with step S107 in FIG. 45.

In this way, the screens as shown in FIGS. 38 and 29 can be generated and displayed.

Incidentally, in the case of the processes in FIG. 45, the position of the viewpoint is fixed relative to the time axis of the absolute time in the display screen in FIG. 38, and therefore, once X and Y axes are selected, it is only necessary for the processes to either display the contents and events, which have been selected, retrieved and extracted, within the display range of Z axis (the range of Z axis in the user view space), or change the displayed position only within the changed display range of Z axis.

On the other hand, in the case of the processes in FIG. 46, when the view information is changed, e.g. the position of the viewpoint is changed, once the display screen in FIG. 39 in the user view space has been determined and generated, the display screen in FIG. 39 must be regenerated based on new view information.

Therefore, the process to generate the display screen in FIG. 38 is less loaded than the process to generate the display screen in FIG. 39. The processor for generating the display screens in FIGS. 38 and 39 may be one of other processors than that shown in FIG. 2. In this case, however, a GPU (Graphics Processing Unit) having a 3D graphic engine is preferably used in the case of the display screen in FIG. 39.

Incidentally, in making a display such as in FIGS. 38 and 39, the user may be allowed to change the time resolution. In this case, some units for the time resolution, such as minute, hour, day, month, year, decade, and centenary, may be provided in advance, and the user is allowed to select any desired unit for display from them. The user can display in minute when viewing a section of time of the day, and in centenary when viewing a section of past and old time. Therefore, because the user can view the user view space in a selected unit, association between contents and events is easily recognized by the user.

As described above, according to the fourth solution, event occurrence date relative to a reference time is included in (or associated with) contents information for each of contents, and the date is displayed on the screen so that concurrence and association of event occurrence dates between contents can be recognized, thereby the user can easily retrieve a desired scene or contents from plural video contents.

A program that performs the operation described above is entirely or partially recorded or stored on a portable media such as a flexible disk, CD-ROM and the like, as well as a storage device such as a hard disk, and can be provided as a program product. The program is read by a computer to execute entirely or partially the operation. The program can be entirely or partially distributed or provided through a communication network. The user can easily realize a video contents display device according to the invention by downloading the program through the communication network to be installed on the computer, or by installing the program on the computer from a recording media.

Although the foregoing embodiment has been described using video contents by way of example, the present invention may be applicable to music contents having time-related information such as produced date and played-back date, or may be further applicable to document files such as document data, presentation data, and project management data, which have time-related information on, e.g. creation and modification. Alternatively, the invention may be applicable to a case where a device for displaying video contents is provided on a server and the like to provide a video contents display through a network.

As described above, according to the foregoing embodiment, a video contents display device can be realized with which a desired scene or contents can be easily retrieved from plural video contents.

The present invention is not limited to the embodiment described above, and various changes and modifications may be made within the scope of the invention without departing from its spirit.

What is claimed is:

1. A video contents display apparatus, comprising:
a static image generation unit configured to generate a predetermined number of static images by considering a time of lapse from information about recorded video contents;
an image conversion unit configured to convert a static image other than at least one specified static image into an image reduced in a predetermined format from the predetermined number of generated static images; and
a display unit configured to display a sequence of images by arranging the at least one static image and the other static image along a predetermined path on a screen by considering the time of lapse.

2. The video contents display apparatus according to claim 1, wherein
the static image generation unit generates the predetermined number of static images for each of plural video contents;
the image conversion unit converts, for each of the plural video contents, the other static image into the reduced image in the predetermined format; and
the display unit displays each of the plural video contents by arranging the sequence of images.

3. The video contents display apparatus according to claim 2, further comprising:
a determining unit configured to, when one of the plural static images of one of the plural video contents is specified, determine whether or not there is a static image relating to the specified one static image in static images of content other than the one content in the plural video contents, wherein
the display unit performs predetermined highlight display on a static image determined as the related static image as a result of the determination of the determination unit.

4. The video contents display apparatus according to claim 3, wherein
the determination unit determines whether or not there is a static image relating to the specified one static image depending on whether or not there is a static image having contents information the same as or similar to the contents information relating to the specified one static image.

5. A video contents display apparatus, comprising:
a time information storage unit configured to store time information about plural time axes for each of plural recorded video contents;
a position determination unit configured to determine a position on plural specified time axes for each of the plural video contents according to the time information about the plural contents stored in the time information storage unit; and
a video contents display unit configured to arrange and display each of the plural video contents according to the position information determined by the position determination unit on a screen of a display device corresponding to a time axis of the plural specified time axes in a predetermined display mode.

6. The video contents display apparatus according to claim 5, wherein
specification of the plural specified time axes is variable.

7. The video contents display apparatus according to claim 6, wherein
a size of the predetermined display mode is proportional to time length of the plural video contents.

8. The video contents display apparatus according to claim 5, wherein
the number of the specified plural time axes is 2 or 3.

9. The video contents display apparatus according to claim 8, wherein
the specified plural time axes comprise at least one of a time axis of period setting of the video contents and a time axis of a production time of the video contents.

10. The video contents display apparatus according to claim 8, wherein
specification of the plural specified time is variable.

11. A video contents display apparatus, comprising:
a time information storage unit configured to store time information about plural time axes and event time information indicating a time at which one or more events occur about predetermined reference time, for each of plural recorded video contents;
a position determination unit configured to determine each position of the plural video contents of plural specified time axes and a position of the one or more event on a reference time axis about the predetermined reference time for each of the video contents according to the time information and the event time information, stored in the time information storage unit; and
a video contents display unit configured to relate each of the plural video contents to a time axis of the plural specified time axes in a predetermined display mode according to information about a position of each of the plural video contents determined by the position determination unit and a position of the one or more event, and display and arrange the one or more event on a screen of display device corresponding to a time axis of the reference time axis.

12. The video contents display apparatus according to claim 11, wherein
the predetermined time is an absolute time.

13. The video contents display apparatus according to claim 11, wherein
the predetermined video contents display unit displays each of the plural video contents on the screen of the display device in a display mode as viewed from a direction orthogonal to a time axis of the predetermined reference time.

14. The video contents display apparatus according to claim 11, wherein
the video contents display unit displays each of the plural video contents on the screen of the display device in a display mode as viewed from a set view point for a time axis of the predetermined reference time.

15. The video contents display apparatus according to claim 11, wherein
the video contents display unit can select one of displaying each of the plural video contents on the screen of the display device in a display mode as viewed from a direction orthogonal to a time axis of the predetermined reference time, and displaying each of the plural video contents on the screen of the display device in a display mode viewed from a set view point for a time axis of the predetermined reference time.

16. A method of displaying video contents, comprising:
generating a predetermined number of static images by considering a time of lapse from information about recorded video contents;
converting a static image other than at least one specified static image into an image reduced in a predetermined format from the predetermined number of generated static images; and
displaying the at least one static image and the other reduced static image as a sequence of images arranged along a predetermined path on a screen by considering the time of lapse.

17. A program product for realizing a method of displaying video contents, used to direct a computer to perform the process comprising:
a static image generating function of generating a predetermined number of static images by considering a time lapse from information about recorded video contents;
an image converting function of converting a static image other than at least one specified static image into an image reduced in a predetermined format from the predetermined number of generated static images; and
a display function of displaying at least the one static image and the other static image as a sequence of images arranged along a predetermined path on a screen by considering the time of lapse.

18. A method of displaying a video contents, comprising:
storing time information about plural time axes for each of plural recorded video contents;
determining a position on plural specified time axes for each of the plural video contents according to the time information about the plural recorded video contents; and
arranging and displaying each of the plural video contents according to information about the determined position in a predetermined display mode on a screen of a display device corresponding to a time axis of the plural specified time axes.

19. A method of displaying video contents, comprising:
storing time information about plural time axes and event time information about a time at which one or more events occur with respect to a predetermined reference time for each of plural recorded video contents;
determining each position of the plural video contents on plural specified time axes, and a position of the one or more events on a reference time axis about the predetermined reference time for each of the plural video contents according to the stored time information and the event time information; and
relating each of the plural video contents to a time axis of the plural specified time axes in a predetermined display mode according to information about a position of each of the plural determined video contents and a position of one or more events, and arranging and displaying the one or more events on a screen of a display device corresponding to a time axis of the reference time axis.
